(19) United States
(12) Patent Application Publication
(10) Pub. No.: US 2013/0181901 A1
(43) Pub. Date: Jul. 18, 2013

(54) Multiple Screens for Immersive Audio/Video Experience

(71) Applicant: Kanye Omari West, New York, NY (US)

(72) Inventor: Kanye Omari West, New York, NY (US)

(21) Appl. No.: 13/734,081

(22) Filed: Jan. 4, 2013

Related U.S. Application Data
(60) Provisional application No. 61/585,987, filed on Jan. 12, 2012.

(51) Int. Cl. G09G 5/14; G06T 1/60

(52) U.S. Cl. CPC G09G 5/14; G06T 1/60
USPC 345/161; 345/1.3; 345/547

(57) ABSTRACT

A audio/video experience comprises two or more viewing screens of at least one front-located screen in front and at least one of either an above, ceiling screen located above and/or one bottom screen located below or slightly forward of the viewer. Side, wall-mounted screens located on at least one side of the viewer can be provided. The images projected on each screen are visually integrated with that of the front-located screen to provide fully immersive, realistic yet virtual viewing. The above, ceiling-mounted screen provides an overhead view of what would be projected above a viewer (coordinated to the front screen images) while the bottom screen provides a downward view of images visually coordinated to the images projected and viewable on the front screen. The bottom screen can be a stage. Alternatively, the various screens can be screen sections of a single video monitor.

### RELATED APPLICATIONS

The present application claims priority on U.S. Provisional Patent Application Ser. No. 61/585,987 filed Jan. 12, 2012. The specification and teachings of that reference are specifically incorporated herein.

### BACKGROUND OF THE INVENTION AND DISCLOSURE

The present invention relates to a multi-screen, video-immersive viewing and entertainment system and experience, intended for both theatrical and home use. The invention comprises the use of at least two screens, preferably at least four, and more preferably contemplates the use of seven or more video screens surrounding one or more viewers for a fully immersive, realistic and exhilarating cinematic viewing experience. Each video screen or monitor display device can have the same projected image for display and viewing by the audience but the full immersive “experience” and excitement of the video system is thought to be best provided where the screens have projected upon and thus display or show the viewer different but spatially associated video images to one another. More preferably, the screens will project and have viewable video images which provide the centrally-located viewer(s) with his/her/their point of view on the front/forwardly-located or central screen with the other screens, on the sides, above and/or below, showing a still but preferably moving video image corresponding to that which the viewer would see to the side, above and below in relation to the image shown on the front screen.

Thus, in a simple example, if the front screen carries a moving image of a building first in the far distance, yet slowly increasing in size as the viewer, the point of view, slowly approaches (by walking, riding in a vehicle, or bicycle riding, etc. towards that building) then the side screen images will show landscape or buildings (if the scene being portrayed is in a city) on the side screens, with or without sidewalks, for example, with those images seemingly passing rearwardly as the walker/rider (the viewer) continues his relative yet virtual movement towards the front located building. Thus, the building shown on the front screen will increase in size as the viewer seemingly gets closer to it (virtually) and the buildings shown on the side monitors or screens pass rearwardly, virtually, as the viewer continues to seemingly walk or ride forwardly. Thus, the displayed video images on the side screens are spatially related to the image projected and viewable on the front screen.

Relatedly, the seeming movement of the viewer (on the front located screen) virtually progressing towards the front-located building as the viewer walks towards it, can be accompanied by the apparent i.e., virtual, rearward relative movement of the sky, above the viewer, on an above-located screen, with clouds, moving at the same speed, virtually rearwardly, as the apparent forward movement of the viewer, as seen on the displayed images on the forward screen.

Then, of course, the screen located beneath the viewer(s) (on or just below the floor; either directly beneath the viewer(s) seat location or just slightly forwardly of the seat locations) can spatially display the virtual relative rearward movement of the roadway upon which the viewer is seemingly walking or riding upon. The images of the roadway will appear to move rearwardly as the viewer seems to get closer and closer to the increasing-in-size building located in front of him/her, as depicted, realistically, on a screen located ahead, by the increasing in size of that building as portrayed by the images projected and viewable thereon. All images are preferably displayed simultaneously and all images are preferably spatially coordinated so that the images the viewer “sees” on the various screens are those images he would anticipate seeing if he/she turns his head, side to side and up and down and while generally facing towards the front of the theater. The monitors, acting together (through appropriate stored images, computer CPUs, switches, etc. similar to a video game, for example) display multiple views for the viewer with the views shown or displayed on the screens being spatially and speed-wise coordinated to one another to provide a realistic virtual and substantially enveloping environment. A fully immersive visual experience is thus provided.

As exciting and interesting as the initial above-described example can be, it is still merely a person walking or riding on a roadway towards a building straight ahead with buildings on his sides and the sky, with clouds, located above and the roadway seemingly moving rearwardly below. Interesting, sure, but clever imagination can lead to even more stupendous coordinated displays, experiences and immersive theater and entertainment experiences.

Transferring then, the above general concept, from a person walking or riding down a roadway and towards a building to the rapid movement and spatial freedom of a pilot of a fighter jet or missile-carrying airplane in the sky above the earth, with multiple other planes in the attack squadron maybe encountering one or more airplanes of a defending squadron of planes, possibly in an airplane “dog fight,” for example. This makes the immersive experience truly life-like, exhilarating and fantastic. A virtual experience which is extremely life like can be achieved. The video can be displayed in a pre-programmed format or the viewer(s) can control the same as in a video game. If implemented properly with suitable video content stored and then displayed for the various screens, this system can be a huge entertainment success, whether it is designed for a home environment, a media room, or an entertainment theater.

At least one, preferably both, of a ceiling-located screen and a bottom or floor located screen are provided to carry projected images (still and/or preferably moving pictures or video) always corresponding to or coordinated with the images projected onto the screens located to the front and the sides. Collectively, the viewer is provided with a fully immersive, multi-dimensional video experience, enhanced all the more by the use of appropriate sound and sound localization features (sounds emanating from the right, for example, will be heard on the right (a plane launching a heat seeking missile on the left will be heard on the left; a dog on the right screen (in the urban scene) could be heard to be barking on the right side and the sound of a taxi passing on the left could be seen on the left screen and seemingly heard, there, too.). The sound system should be coordinated, too, to the visual content shown on the screens and the sounds can be panned in typical surround sound technology to coordinate to the movement of the virtual person through the displayed environment. Fully integrated in sound and video images, the present invention would provide the viewer with moving (or still) images on multiple and surrounding screens and, yet, preferably, the images are so well visually and sound integrated and coordinated that the viewer sees on the screens that which spatially “flows” from that which he views on the forward screen, all as the image of the front screen(s) changes over time.

If the viewer looks upwardly and then downwardly with respect to the primary images projected on the front screen, he will see that which corresponds to the above and below view, respectively, of the image projected of the front screen, taking into consideration the distance between the front screen and the viewer's seat location and the relative yet virtual “speed” of movement, if at all, of the viewer moving towards the front screen. The images are intended to be collected and displayed from the point of view of the viewer although other image collection and projection systems can be employed. If the image of the front screen changes, then the corresponding image(s) on the side, above and below screens correspondingly change so that the viewer is, at all times, substantially surrounded with video images (and sounds), projected onto screens and heard through speakers, which are spatially coordinated to one another and especially to that which is viewed on the front screen. Other variations are possible, too, of course.

Alternatively, instead of having all screens display the images spatially related to the displayed images on the front screen, i.e., corresponding to that which the viewer sees from his/her seat when looking forwardly and the side, above and top screens being those images which he/she would see when looking to the side, towards the ceiling or towards the ground or floor, the images could be spatially corresponding to those of an object, scene, etc. For example, if a scene shown on the front screen is that of a castle under siege, then the front wall might show the front of the castle, with its large doors closed and a moat, while the side walls would show the sides of the castle, the above, ceiling mounted screen showing the view of the castle from above, and the bottom, floor-mounted screen either showing the courtyard or flooring of the castle, or, alternatively, possibly a blueprint of the castle's interior, showing the various rooms, the location of arms, the King or Queen, the Treasury, etc. This would be especially helpful for display and enjoyment of a video game.

In an alternate embodiment, maybe the image shown on the front screen is a perspective view of a swimmer in a swim meet. The other front screens could display the adjacent swimmers, in their lanes, in perspective, too. The side wall screens could carry a moving image showing the race as viewed from the sides, thereby easily showing the lead swimmer and the other swimmers as they progress across the pool, within their lanes. The above, ceiling mounted screen would be a view from above the pool, again showing the swimmers as they progress across the pool and the bottom, or floor-mounted screen could display images of the lead (or several swimmers) as seen by a camera from below the bodies of the swimmers, showing their faces when in the water looking down, their kick, the turn at the wall, etc.

A viewer would experience viewing the images of a broadcast or cable television program, pre-recorded or live scenes, events (races, for example, sporting events), a movie, a video game, a music video, etc. as if he or she were actually “in” the scene. The use of the multiple and surrounding video screens and moving images transforms the viewer into that environment. While stationary, likely even seated, the viewer will be made to “feel” as if he/she is moving as the moving images on the various screens change, all spatially coordinated to the changes shown on the front screen. The use of the multiple screens “surrounding” the viewer provides a surround video experience and truly immerses the viewer into the projected images. This is primarily accomplished by positioning at least one viewing screen, preferably three, in front of the seated or standing viewer(s), one or more screens located to the sides of the viewer(s), within the environment (like a video screening room, den, theater, etc.), and one screen, preferably two, either above on the ceiling and/or below on or below the floor directly below the seated or standing viewer or just slightly in front of their head and feet on the floor so that a mere downwardly tilt of the head will allow the viewer to seemingly see that which is below him, spatially coordinated to that which he/she will see on the screen in front of him. Projected and preferably distinct video content, in the form of still and moving images onto the screens, all corresponding to the point of view of the viewer(s) and the location of the screens in relation to the viewer(s) will complete the fully immersive, surround video viewing experience.

Locating the viewer(s) within the general central area of the video entertainment environment, whether it be a simple room, a video room, a full entertainment complex, etc. provided with the screens on the front wall, possible on the side wall(s) and one or both of the ceiling and/or floor, all as set forth above, and having each screen projecting the image(s) that corresponds to the location of the screen and coordinating the images and video content shown on the front screen, will provide an exciting and fully immersive visual experience. The present invention is expected to accomplish for the video experience what surround sound has accomplished for the audio experience. Coordinating the present video screens and projected images with surround sound-like audio will enhance and amplify the overall immersive experience to maximum enjoyment and desired effect.

At its minimum, the present invention comprises the use of at least one video screen in front of a viewer (positioned as any television, monitor, rear or front projection image projecting device or movie screen would be) and at least one screen suspended or located above and/or below the viewer. In the context of the screen located below the viewer, the projection of the image or video content onto that screen can be by a rear projection mechanism with the projector located beneath the floor supporting the chair upon which the viewer sits or via a video monitor with suitable cable connections. Alternatively, the bottom or floor-located screen can be protectively housed behind a glass-like or otherwise translucent or transparent screen or window with the image projected thereon and still visible in any currently known or to-be-developed manner. The preferred embodiment of the present invention, however, differs dramatically from a video or entertainment room which is presently available containing a monitor, large screen TV, HDTV, or movie screen, etc. located in front of the viewer(s) in that, according to the present invention, there will be a total of at least two screens, at a minimum—a front image projecting screen or the primary or principal video monitor or screen and either or both of an above or ceiling mounted screen and/or the below or floor screen, each displaying preferably a different but spatially coordinated set of moving images or video content yet corresponding to the moving image shown on the front screen.

According to the preferred embodiment of the invention, two additional front-located screens are provided adjacent to the main, principal and central, front located screen. They are considered front located screens yet in the preferred embodiment are not precisely co-planar with the central front screen. Rather, preferably, they project at a slight angle rearwardly extending towards the viewer, off of the flat vertical plane on which the front screen sits, to provide an enclosing or enveloping “feel” to the environment. These “angled” yet also front image projecting screens extend from the side edges of the front, central and primary screen toward the side walls of the entertainment room and slightly back towards the viewer(s). They can be mounted on the front wall or “caty-cornered” and extending between the front wall and the side walls. Preferably they will laterally “extend” the viewed images of the front screen so that a more panoramic and substantially continuous image on the front screen(s) will be seemingly displayed. In the preferred embodiment, the aspect ratio of the front screen should be movie box size but surely at least 4:3. When the canted front screens are located adjacent to the principal front screen, a seemingly continuous and panoramic video display is provided. Of course, cameras for recording and projectors or computer systems for displaying the images onto the screens need to be available but this is well within the skill of the art of cameramen, projectionists, those in the movie, television, video game industries now, i.e., those familiar with recording and play back of television and movie production.

Additionally, and also preferably, there are one or two screens positioned on only one but preferably on both sides of the centrally located viewer, i.e., located on the side walls of the entertainment room (or suspended by appropriate support means) and adjacent the side of the viewer(s) while he/she faces forwardly towards the front central screen (or, as mentioned, facing the three-front screens—one in the center and two extending from the front wall and slightly angled towards the side walls). These wall screens on the side walls are preferably co-planar with the side walls themselves or suspended in parallel fashion to the viewer's eye line of sight as he/she faces forwardly. These side wall screens will display video images thereon preferably again corresponding or coordinated to the displayed images the viewer sees of the images projected on the front screen(s). The viewer can merely turn his head in that side direction and those images thus correspond and relate in spatial relationship to the moving images shown on the front screen(s). The side wall screens preferably extend on the side wall, starting near the front wall of the entertainment room to a point closely behind the rear of the head of the viewer(s). The side wall screens will show moving video content or still images, spatially corresponding to the images shown on the front screen but spatially, speed-wise and distance, realistically replicating the viewer's view of the moving images on the front screen, but if he/she were viewing images to the sides. This allows the viewer to not only have a peripheral view of the images being viewed as he/she looks forwardly, but also to simply turn to either side to see the moving image(s) which would be on that side of the viewer if the viewer were actually at the location of the seat as distanced with respect to and as depicted on the front screen. In this manner the viewer(s) are fully immersed in the action of the broadcast program, movie, video game, or music video, etc. The overall and realistic effect, combined with surround audio is expected to be highly entertaining.

In addition, and possibly quite importantly, one or more screens are placed both on the ceiling above the head(s) of the viewer(s) and on the floor under or adjacent yet forwardly of their feet so as to provide a comprehensive and substantially complete experience. Two and up to five-sided additional screens for a fully immersive viewing of the image projected onto the front screen, i.e., a substantial full range of image viewing experience is provided. The floor screen could be a video monitor, HDTV, rear or front projected screen, etc. and, if needed, protected by a sheet of glass, or some other translucent or transparent protective platform, so that the viewer can sit on a seat directly on top of it without damage nor impact to the screen nor projected image but, as desired, look downwardly and see the moving images projected thereon. Again, while not necessary, it is preferred that the images on the bottom or floor-located screen correspond and are spatially coordinated to the moving image(s) projected onto the front screen(s).

Looking at the screen on the ceiling above, the viewer(s) would see what is intended to be projected above him or her—again, coordinated spatially and with speed and distance, to that displayed on the front located screen. Looking at the above or ceiling screen and the images on the floor-located screen below, the viewer would see what is intended to be projected above and below him, respectively, all corresponding, spatially, preferably, to the moving images projected onto the front screen(s). This effect is especially dramatic and immersive because the viewer can essentially see around him in all directions (the back wall, too, could be provided with a screen with suitably coordinated moving images) making the moving images and viewing experience as dramatic, life-like, and immersive into the action and the scene(s) shown on the front screen(s) as possible, all from the perspective of the viewer(s) centrally located and sitting (or standing) upon the floor (itself an imaging-projecting screen). While not actually moving, the viewer is given the immersive feel of movement and location of that which is projected onto the front screen, as that image is enhanced and coordinated by images of video content projected onto and displayed on the front, side, above and/or below screens.

For a mere first and non-limiting, example, if in a video game context, the images rapidly shown on the front screen(s) is of an individual viewer as if he/she were located in the cockpit and on a seat of a fighter jet, the screen at the center of the front wall will show fast moving images of the fighter jet passing forwardly through the sky as it is directed towards a location, say a nuclear facility. The video content or images on the side wall screens, should the viewer merely slightly turn his head, will show video images corresponding to quickly rearward movement of sky, too, and, in addition, for example, maybe one or more fighter jets in formation along with the central fighter jet. The viewer would thus see, possible slightly trailing his/her jet, the jets of his comrades, in formation, as the fighter squadron approaches the facility for a bombing raid. The side screens would thus have displayed thereon that which the viewer would see, if he/she were sitting in the cockpit of the jet fighter, if he/she were in formation with and flying with other fighter jets. All he need do would be a simple and slight turn of his head to look sideways. There he would see, on the side screens, the spatially related images to what he sees on the front screen—rapidly approaching a nuclear facility, rearwardly and rapidly moving sky, with the other fighter jets, maintaining speed along with the fighter jet which is being flown by the viewer. The moving images on the sides would possible show some slight up and down relative movement of the side-located fighter jets for a true realistic look and feel as they tend to slightly move with respect to the lead jet, even when flown in formation. Also, those side-located screens could have the fighter jets seen thereon moving slightly rearwardly or “peeling off” as the central jet moves closer and closer to the nuclear facility. Alternatively, on one or more side or front located screens, non-friendly jets of the same or different type planes can be seen. These could be displayed on the side screens so that the viewer senses that he is being attacked. These, too, are spatially coordinated to the position, speed, etc. of the main jet displayed on the principal and centrally located screen. To complement the overall imaging and immersive experience, passing clouds, other planes, buildings or things in the horizon, etc. could be visible on the side screens, all coordinated to that which is visible and quickly approaching as seen on the front screen. Over time, the images will change on the front and side screens to replicate, without actual motion by the viewer, the virtual experience the viewer would “feel” if he/she were actually within a fighter jet moving rapidly in the sky. He/she would visually experience the rapid movement through the clouds, first possible forwardly depicted on the front screen(s), and then those same clouds may be shown moving rapidly rearwardly, as the jet seems to progress forwardly, towards the target, the nuclear facility. The rapid movement of the fighter jet through the clouds, if he/she turns their head to the side and views the images on the side screens, will be dramatic and immersive. The viewer will likely feel as if he/she is really flying and on a combat mission. The slightly angled or canted screens at the front of the viewing room or environment will show the peripheral viewing images of the sky adjacent to the front of the fighter jet (just as a fighter jet has peripheral viewing windows to allow the pilot some range of view beyond merely straight forward). The side wall located screens will show, for example, possibly one or more other jets flying in formation with the seated viewer and his jet and their rapid group-like travel through the air. This experience is expected to be highly entertaining and immersive as the viewer will feel like a real air force pilot. All images projected on the front-located screen(s) will coordinate and drive the images to be seen on the side, above and below screens. All images will be spatially and speed-wise coordinated with one another for a fully realistic effect.

Located beneath the viewer, projected onto the screen at his/her feet, will be an image of the ground, seemingly moving rapidly rearwardly, as the high speed fighter jet or plane moves forwardly through the sky. Similarly, located above and substantially forwardly of the viewer's head, will be the ceiling-located screen which might show additional clouds, another jet (maybe an attacking jet from above) the night sky, the moon, etc. as if it were above the primary fighter jet of the viewer's location. All images are projected onto the screens and when coordinated, a very realistic environment is provided, a fully immersive and visually surrounding experience. Coordinating and changing the projected images to movement of a joy stick, for example, in a video game, and allowing the viewer to control the joy stick, which controls the projected images onto the front wall screen(s), those on the side walls, ceiling and floor, etc. will allow for a truly exciting fighter jet game experience and a fully immersive, highly entertaining video (and audio) experience.

Of course, the same technology disclosed herein can be employed with a huge variety of moving (and even still) projected images. As yet another non-limiting example, the viewer can experience the “feel” by viewing the blast off on a rocket as if he/she were located in a capsule during launch on a rocket from earth towards the moon or another planet. At the screen located on the front wall, the viewer will initially see upwardly, then, after launch, the horizon of the earth located forwardly of his seat and rapidly moving relatively downwardly as the rocket takes off and lifts into orbit, on the front screen(s) on the side wall screens, on the bottom and ceiling or above screens. So, for example, after takeoff, the bottom or floor screen would display the receding and quickly “shrinking” of the early below. The images will show the earth moving rapidly away, seemingly downwardly as the rocket moves relative upward (at increasing acceleration) from the launch pad. The below or floor located screen would show the floor of the capsule and/or the upward rapid movement of the rocket and capsule as it leaves the ground and the ceiling-located screen could show the images corresponding to that which a camera housed in the nose cone of the rocket would “see” as rocket and capsule are launched into orbit, with sky and stars (maybe moon) rapidly approaching from above.

Other images are contemplated, too. For further non-limiting example, the viewing experience could be that of a viewer travelling in a four wheel vehicle on safari—front screens showing where the vehicle is headed, side screens showing vistas, trees, animals, seemingly moving rearwardly (as if one is within a vehicle as it moves forwardly) and the ceiling-located screen showing the movement of the vehicle relative to the trees, clouds, stars, or sky. The bottom-located screen could show, in this example, the vehicle's relative movement over grass, a path, through and across streams, rock, dirt, road, etc.

Another non-limiting example might relate to moving images meant to simulate and immerse one or more viewers into an experience on a motor boat at high speed over water. Here, the front screen(s) would show, for example, an enlarging image of an island as it is being approached by the speeding boat. The side-located screens would depict images showing a beach, other islands or trees, seemingly moving rearwardly as the boat moves forwardly through the water and towards the island shown on the front screen(s). The bottom screen could show relative movement of the boat over the water with fish, reef, sand bottom etc. seemingly moving rearwardly and the ceiling-located screen could depict the relative movement of the boat in moving and spatial relationship to the sky, clouds, stars, a moon in the sky, etc. Again, the overall experience is expected to be dramatic, realistic, and exhilarating.

The use of the various screens will create a much greater video and audio experience than a mere singular monitor, HDTV, rear or front projection screen for images, even an IMAX large screen—as the location of the screens on the sides, on the ceiling, and/or on the floor of the viewing theater gives a much more life-like, realistic feel to the video, and attaches a full range of video images to the traditional surround-sound device. The greatest effect is expected to emanate from a combination of front and front-peripheral views, which may be present in other inventions, with the use of additional and spatially coordinated video images both above and/or below the viewer, further enhanced with coordinated and spatially related video images projected onto the screens on the side walls. Maximum immersive impact is believed to be attained by further coordinating the surround video imagery with a surround sound system.

In an alternate embodiment, the invention can take the form of an on-line video game or experience which uses a single monitor or screen where the screen display surface is segmented into various areas to simulate the front screen, a top or ceiling mounted screen, side screens, and a bottom or floor located screen. These areas of a single planar surface can still provide a virtual and immersive experience of a multiple panel or screen theater experience as set forth in the preferred embodiment (on the theater level).

### Description of Prior Art

To the Inventor's and Applicant's knowledge, the use of video screens on the sides of a viewer in order to give a peripheral view of the image displayed (in addition to front-located screens) may be shown and known by prior art. One such example is a cyclorama theater, which is a panoramic screen designed to provide a viewer, standing in the middle of a large vertical cylinder of inwardly facing screens, along with many other viewers, with a 360 degree view of a portrayed set of images. However, the new and patentable distinction of the present invention is the use of the screens above and/or below the viewer(s), in conjunction with the others in front of and on the sides of the viewer, to provide a full range of realistic visual moving images.

Furthermore, to the inventor's knowledge there has been no deployment of a cyclorama for a small scale entertainment room in a residence and, yet, the immersive and similar effect can now be achieved by the present invention's use of a front screen, one or more side screens, and either or both a ceiling and/or a floor-mounted screen. The effect will be dramatic and provide an entirely new experience, whether for a video game being played or for a movie or music video being watched by the viewer(s) in one's home or a new theater environment.

Of course, multiple and adjacent screens on a planar, even a curved surface have been provided, too, with the images projected onto one screen extended seemingly seamlessly onto the adjacent screens. However, to the Inventor's and Applicant's knowledge, to date, no one has considered the synergistic use of one or more additional screens located directly above and/or below the viewer, with the images spatially coordinated to the image projected onto the front and/or side screen moving or still images. Providing above and/or below screens and projected and viewable images, spatially coordinated to that shown on the front screen, all preferably from the point of view of the viewer(s) in the approximate middle of the room or theater, provides a very realistic effect and overall immersive viewing experience.

Some prior art shows visual display devices which include multiple screens or image projections for a greater overall viewing experience, some focusing specifically on the 3D capabilities of the screens. U.S. Pat. Nos. 5,137,450; 7,196,677; 5,487,665; 5,963,247; and US Patent Applications Published with Nos.: 2007/0176848 and 2010/0128112 seem relevant. Of the prior art, some seem to disclose, in some form, a set of video screens which include a front-located screen, as well as screens on either side of the viewer's head. That, of course, is not believed new. U.S. Pat. 5,137,450 to Thomas discloses a substantial wrap-around display system for a flight simulator for an aircraft pilot with a “plurality of flat rear-projection screens.” As can be seen in the drawings used for that issued Patent, the screens are placed all around the pilot's head as if he is sitting inside a cockpit. There is no teaching however of a display screen located above, as a ceiling mounted screen for a general theatrical viewing nor of a screen extending partially behind the head of the viewer/pilot/video game user nor any suggestion of a video display screen located directly beneath the seat of the pilot or the theatrical audience. What is shown, however, by this reference and some of the others, is a display screen below the front screen which is intended to show an extended view of the front screen but below the image displayed on the front screen. The present invention, however, provides a bottom, floor-like mounted screen which is closely adjacent the feet of the viewer. This is markedly different. Also, there is no mention in the prior art of a bottom view screen extending to below the seated pilot.

U.S. Pat. No. 5,487,665 to Lechner is also relevant prior art. It discloses a video system including a video screen located atop the seated viewer (again for pilot training) and having contiguous display screens on each side of the viewer protruding outwardly and backwardly from the plane defined by the front screen (see FIG. 1). There is, however, no suggestion of employing such a set of screens in connection with a personal theatrical environment or a theater for a large audience or of using such a system for a multiple of other imaging purposes beyond training fighter jet pilots. Also, the Lechner reference does not show a video display or screen located directly above the head of the user and surely no teaching of a video display screen below the seated user/viewer.

U.S. Pat. No. 5,963,247 to Banitt (See FIG. 2A) shows and discusses the three-dimensional feel achieved from providing a multitude of screens because the images are shown on a variety of planes, not just the flat surface in front of the viewer. The drawings thereof, FIGS. 1, 2a, 2b, 2c, and 3, of that patent do not disclose screens directly above nor below the seated user, as the present invention contemplates. The reference only shows images of screens located to the side of the front main, front located or principal screen.

US Patent Application 2010/0128112 to Marti discloses in FIGS. 1A and 1B, video display screens on the sides, and seems to show images as if below the viewer but not by use of a below or bottom, floor-like mounted screen physically below the feet of the viewer. It is similar to that shown by the Thomas reference, referred to above. Rather, this teaching appears to be a lower-located yet still front-of-the-viewer screen and is intended to carry images of what the viewer would see just below the image of front screen but not images below the viewer or a bottom view of that which is visible on the front screen. In contrast, the present invention provides a screen upon which the viewer actually sits or a display screen which is either co-planar with the floor upon which the viewer's seat is located or near to the feet of the viewer. As detailed below, in an alternate embodiment the below, floor-like mounted screen can be canted towards the viewer(s) so that the forward or distal edge of the screen is above floor level with the rearmost or proximal edge (nearer to the viewer(s) at or just above floor level or the canted or tilted screen can be entirely below the floor level of the theater yet still canted or tilted such that the forwardmost edge, the distal edge of the screen is higher in elevation than the near-most or proximal edge of the screen—the entire screen can be sub-floor located.

It is believed that video games and on-line video experiences have employed segments of the video monitor to display visual areas of interest to the viewer/player. Some of those areas may even have carried alternative views of the video being shown on a central segment primarily seen on the monitor, e.g., the main portion of the monitor displays the imagery of that which the viewer believes is in front of him and the side of the monitor can provide imagery of a top view of that which is shown on the front screen. However, to applicant's and the inventor's knowledge, there has been no video game experience, even in a single flat screen, which segments the screen into two or more areas wherein one area is the view of the viewer as if facing forward, toward the action, and another screen is either a top or a bottom view, above or below the viewer/gamer/user, if the same tilts his/her head upwardly or downwardly, respectively.

### SUMMARY OF THE INVENTION

The present invention comprises a multi-screen surround video (supplemented preferably with audio) experience which provides a viewer with a full set of moving images corresponding and related, spatially, to the image(s) projected onto the front-located screens. The preferred embodiment comprises the use of seven screens; three in front of the viewer (one centrally located and the other two edge to edge therewith yet preferably angled off of the front wall so as to provide a surround video feel) with one or more side-wall located screens, corresponding to and substantially parallel to the sides of the head of the viewer(s). The aforementioned angled front screens extend slightly rearwardly and outwardly from the front wall yet rearwardly toward the viewer(s). One screen is preferably located on each side of the central front screen, allowing a degree of peripheral vision or view of the moving images viewable by the viewer as he/she looks forwardly yet turns his or her head slightly from the precise forward-facing position. A screen located above the viewer and/or preferably a screen located below the viewer allow the viewer a full range of moving images which can be seen as the viewer tilts his/her head upwardly and downwardly, respectively. Those projected moving images are intended, in the preferred embodiment, to be spatially related to and in motion corresponding to the moving image(s) projected onto the front central screen. This will provide the viewer(s) with the overall viewing experience and the feel that he/she is actually “in” the action, within the images projected onto the front screen and the other screens. A fully immersive and entertaining experience is provided. The screen below the viewer will be provided with some protecting surface, e.g., by being covered with scratch resistant and strong glass, by a translucent platform, etc. so that the viewer(s) can sit thereon, on a seat, and still view the images projected onto the floor-located screen. It is expected that the viewer will more realistically feel as if he/she is actually moving (even though the seat and the viewer is fully stationary during the overall experience) as the moving images on the various screens are coordinated spatially and visually to show relative movement by the viewer through the projected environment.

In an alternate embodiment of the invention, an online or stand-alone video game or visual experience is provided to one or more viewers or players, by use of a single flat-like monitor or screen, where the screen is divided or separated into specific areas corresponding, spatially, to the sides, above, and/or below the imagery being shown on the main, central segment of the same monitor. This experience is believed fully immersive of the viewer/player, too, and provides exciting entertainment.

### BRIEF DESCRIPTION OF THE DRAWINGS

FIG. 1 is a perspective view of the present invention taken from the perspective of a viewer standing at the back of the environment, room or theater. This embodiment depicts both separate screens in a theater or room and, in addition, serves to show how a single video monitor or screen can be separated or divided into areas and used for providing a similar inclusive and immersive, surrounding effect, as if the viewer were actually surrounded, sides, ceiling and floor, with individual monitors.

FIGS. 2-7 are examples of the preferred embodiment of the present invention in use (similar to the schematic shown in FIG. 1) and taken from the perspective of a single, central-located viewer enjoying the multi-screen fully immersive viewing experience. FIG. 2 shows the view of an auto race with the road to be travelled on the front screens; the landscape on the side screens as if a driver of the auto turned his head sidewise, in the auto; an above screen showing the sky; and a below-located screen showing the vehicle as seen from a camera located above, but on the roadway.

FIG. 3 is a view of the same side screens of the auto race shown in FIG. 2, with the front screens, two of which are canted rearwardly from common edge to free edge, showing the landscape far ahead.

FIG. 4 is a view of another set of images projected onto the screens, schematically shown in FIG. 1, with the above, ceiling-like mounted screen showing an image extending above those shown on the front screens, the side screens showing images to the sides of the images shown on the front screen, and the below, floor-mounted screen being that which a person standing or sitting in the environment of the front screens would see if he/she looked downwardly toward the ground. Alternatively, according to the present invention, the below, floor-like mounted display and screen could show any pleasing ground view so that, for example, if the ground were dirt, or merely white but unclean tile, a substitute and more attractive bottom image could be displayed.

FIG. 5 is a view of the present system shown in connection with the interior viewing of a Mosque, with the front screens showing the view of the front of the Mosque, the side screens showing the viewer(s)' view of the side apses of the Mosque (as if the head of the viewer were turned to the sides; and the bottom-located screen shows the central floor of the Mosque with the above, ceiling mounted screen showing the view of the front ceiling of the Mosque.

FIG. 6 is a view of the set of screens where the top-located screen carries an image of a swimmer, from below, and the other screens, front, sides and bottom, are of the water, as would be seen by the swimmer if he turned his head to the front, the sides, and looked downwardly toward the bottom of the pool.

FIG. 7 is a view of a brief segment of a video presentation on the screens of the theater environment and shows a woman on the left screen and a man on the right screen, with the other screens being blank or dark to focus the viewer(s)' attention on the individuals depicted on the screens.

FIG. 8 is a top plan and schematic view of the preferred embodiment of the present invention, showing the rows of seats, the front screens (two of which are rearwardly canted) and the side screens, too. The top screen is shown as being located such that its distal edge projects forwardly of the front row of seats with its proximal edge suspended over the first two rows of seats.

FIG. 9 is a side elevational and schematic view of the present invention with the floor-located screen being shown as tilted at approximately a 45° angle towards the viewer(s)' rows of seats.

FIG. 10 is a rear perspective view of a preferred embodiment of the present invention, showing a set of tiered rows of seats, a set of front screens (two being rearwardly canted or tilted towards the seats and two side wall screens (one in shadow for ease of understanding).

FIGS. 11a-11c are top perspective and schematic views of the present invention, depicting various sizes and aspect ratios for the projectors and the screens for providing different effects and coverage to the screens. Some of the screens are provided with front-located projectors and some with rear-located projectors.

FIG. 12 is an enlarged top and schematic top view of the present invention, relating to FIG. 11a and depicting one embodiment of the projector types (rear projector) used for transmitting images to the viewing screens.

FIG. 13 is a side perspective and schematic view of FIG. 11b depicting an alternate embodiment of the projector types (multiple soft edge stacked and adjacent rear projectors, for example, for the side wall screens and the ceiling mounted screen) as used for transmitting images to the viewing screens.

FIG. 14 is a side perspective and schematic view of the screens and the audience of tiered rows, with each screen provided with a rear projector system and the screens being of a large aspect ratio for a greater field of view than a traditional 4:3 ratio, to allow for panoramic imaging and more realistic viewing.

FIG. 15 is another view, similar and related to that of FIG. 11c, yet depicting another alternate embodiment of the relative sizes of the screens and the use of multiple, rear projectors (two for each of the front screens and the ceiling mounted screen). The use of multiple soft edge or overlapping projectors (whether front or rear projectors) for each viewable screen decreases the distance between the projectors and the screens in comparison to a single projector being associated with a single screen. This can be used to great advantage in designing an entire theater complex for housing the present invention in a minimum of space while still allowing for a fully immersive experience.

FIG. 16 is an elevational and schematic view of one embodiment of the present invention showing the floor screen in a flat position yet facing upwardly and comprised of a set of LED tiles which coordinate and present a single image when a computer, CPU and stored images (or live video feed) is passed thereto. The ceiling screen and the front screens are illustrated, too. The side screens are present and border both sides of the tiered rows of seats in the theater.

FIG. 17 is a side elevational view similar to that shown in FIG. 16, but of an alternate embodiment of the present invention, showing the floor screen in a tilted or canted position with respect to the patrons seated in the tiered rows of seats. The tilted floor screen shows that the distal edge of the screen is coplanar with the bottom of the first row of seats while the proximal end of the floor-mounted screen is below the floor, yet terminates at a point still in front of (towards the front screens) the first row of seats in the theater.

FIG. 18 is a top perspective and schematic view of the construction of one environment or theater for housing the present invention configured as a pyramidal theater. The front screens are shown, with two of the front screens canted or tilted backwards towards the audience; the ceiling screen is shown, and the floor screen also shown, in this case as a tilted towards the audience screen. Various trusses and supports are shown, too. The lighter shading behind the screens is meant to illustrate the projection from a rear-located projector to the rear of the screen which, based on the transmittivity of the screen, will allow the image to be viewed on the front of the screens, in a well-know manner. The exterior roof of the theater shown in this Figure is meant to simulate a four sided pyramid.

FIG. 19 is a perspective view of one embodiment of a constructed theater containing the present inventive multi-screen experience with the theater shaped as a pyramid.

FIG. 20a shows a side elevational and schematic view of an embodiment of the theater for housing the present invention (in the shape of a four-sided pyramid) where one end of the pyramid top can be hydraulically lifted and tilted at a given angle to provide an added level of an exciting experience. This exposes the interior of the theater to allow for patrons to easily and quickly, from three sides, enter and exit the theater. Hydraulic lifts can be suitable placed around the three edges of the pyramidal housing/roofing to facilitate the tilting of the same for this purpose. The left side of the Figures shows the pyramid housing or roofing in its “down” or descended position while the right side of the Figure shows the housing or roofing elevated, along three edges to allow theater-goers or patrons to quickly and easily enter and exit the theater. Other shapes of pyramids can be employed as, for example, a stepped pyramid.

FIG. 20b is side elevational and schematic view of FIG. 20a and shows a large number of suitably located hydraulic lifts beneath a portion of three edges of the housing or roofing of the pyramid-shaped theater to operate the tilting mechanism for ease of allowing patrons into and out of the theater.

FIG. 21a shows a side elevational and schematic view of an alternate embodiment in which the pyramidal-shaped housing or roofing of the theater housing the present invention can be hydraulically raised on all sides or edges to provide an added level of experience and to allow for ease and quickness of ingress and egress from the theater. The left side of the Figure shows the housing or roofing in its down position while the right side of the Figure shows the housing or roofing elevated up by the hydraulic mechanisms to expose the sides for allowing the patrons to enter and exit the tiered rows of the theater.

FIG. 21b is an enlarged rear elevational and schematic view of FIG. 21a and shows the hydraulic lifts underneath the edges of the entire bottom surface of the pyramid-shaped theater to operate the raising mechanism. The rear of the tiered rows of seats is visible. The entire housing or roof of the theater is seemingly raised by the hydraulics to allow 4-sided entry and leaving by patrons from the theater.

FIG. 22 shows an alternate embodiment of the housing or roofing for a theater holding the present invention with the theater's outside being shaped as a cube.

FIG. 23 shows the theater housing or roofing shown in FIG. 22 being vertically lifted by using the hydraulic mechanism as shown in connection with the other Figures.

FIG. 24a shows a side and schematic elevational view of the embodiment of FIG. 21a in which the theater is shaped as a cube. The left side of the Figure shows the housing or roofing in its down or descended position while the right side of the Figure shows the housing or roofing, schematically, elevated by hydraulic means, on all sides of the cube, to allow quick and easy ingress and egress of patrons into and out of the theater.

FIG. 24b is front, elevational and schematic view of a parallelepiped-like housing or roofing of the present invention, and shows the hydraulic lifts underneath the bottom surface of the theater raising the roof and exposing the sides to allow patrons to easily and quickly gain access to and leave the theater. The tiered rows of seats can be seen, facing forwardly.

FIG. 25 is a side and schematic view of another or alternate embodiment of the exterior housing or roofing for the theater holding the present invention with the theater shaped as a hemi-sphere.

The exterior surfaces of the housing or roofing can themselves be screens for bearing images to great effect so as to entice the theater patrons to come closer and enter the theater, as desired.

FIG. 26 is a perspective view of a large stage for a performer(s) at a concert, for example, the stage also serving as a bottom screen for the viewers in the audience to see, along with the front screen(s) and/or the ceiling or top screen(s).

FIG. 27 is a side view of the bottom or stage screen shown in FIG. 26 and illustrates the slope and rise, from front to rear of the bottom screen shown in FIG. 26. The stage/bottom screen is supported by appropriate trussing and cross beams for strength and support, as can be seen. The front edge of the stage/bottom screen can be elevated about 2 feet above ground level while the rear edge is about 6 feet 8½ inches above ground—showing an increasing slope from front edge towards rear edge. This figure also shows that the front portion of the stage/bottom screen may be substantially horizontal, with each attached and rearwardly located section of the stage/bottom screen being tilted, forwardly, towards the viewing audience.

FIG. 28 is a top plan view of the stage and bottom screen shown in FIGS. 26 and 27, and shows the overall (when viewed from the top) trapezoidal shape of the stage/bottom screen along with some dimensions, front edge being about 64 feet and rear edge being about 52 feet, of a preferred stage for a performer and for the screen.

FIG. 29 is a top schematic view of the stage and bottom screen shown in FIGS. 26, 27 and 28 and shows the additional supporting beams below the stage (as if the stage and bottom screen were see-through). Clearly the supports at the front edge of the bottom screen are shorter in length, from below the planar floor to the floor of the arena, than the supports at the rear edge of the bottom screen, with the supports intermediate of the front and rear edge being increasingly long, from the front edge towards the rear edge.

FIGS. 30-33 are comprised of four photos, originally submitted in color, and represent a concert stage in an arena, utilizing the present invention. As can be seen in some of the photos, the foreground of the photos shows a control console with one or more production personnel “manning” the console and attending to various aspects of the performance, e.g., lighting, video, audio, etc. The front of the arena is shown, too, having one or more front screens for video and adjacent front screens, even side wall screens. The adjacent front wall screens extend backwardly and are outwardly canted (from front to back of the theater/arena). These are for video, too. At the top of the arena is at least one video or ceiling screen.

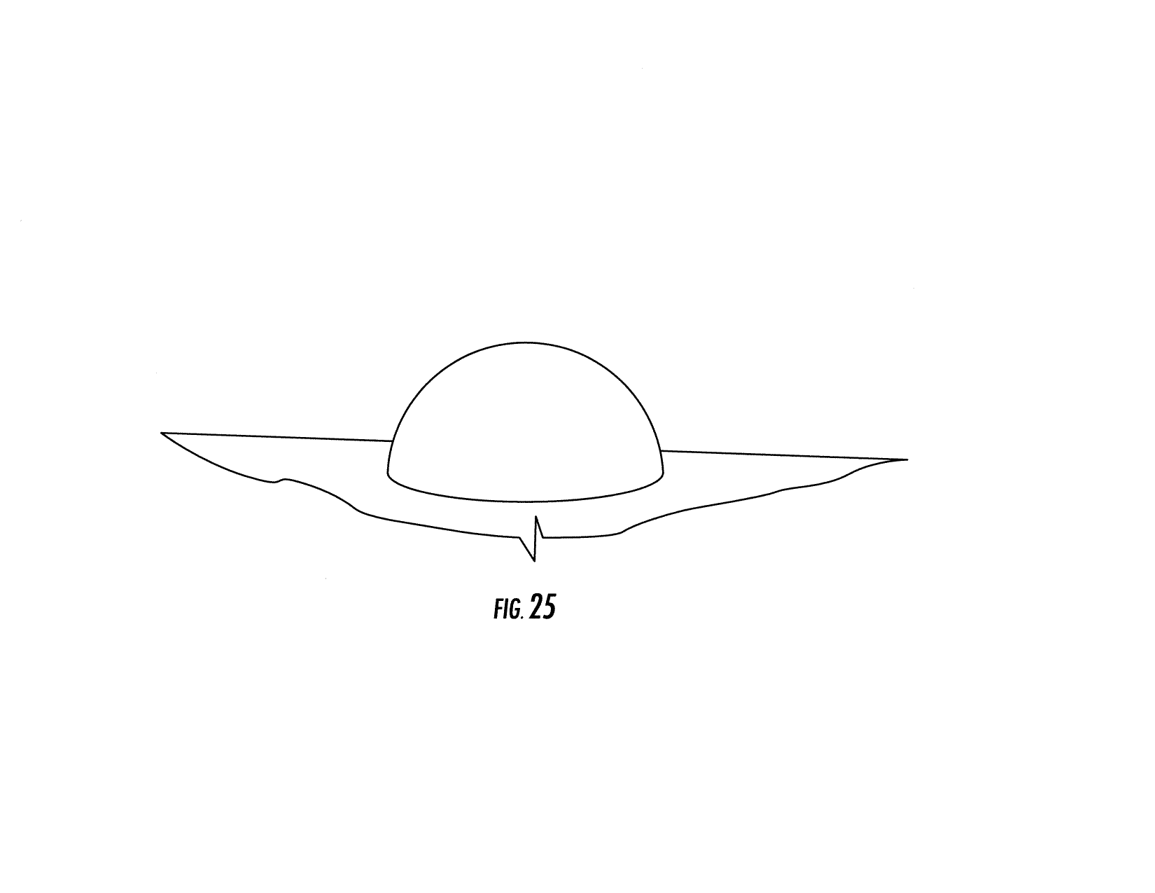

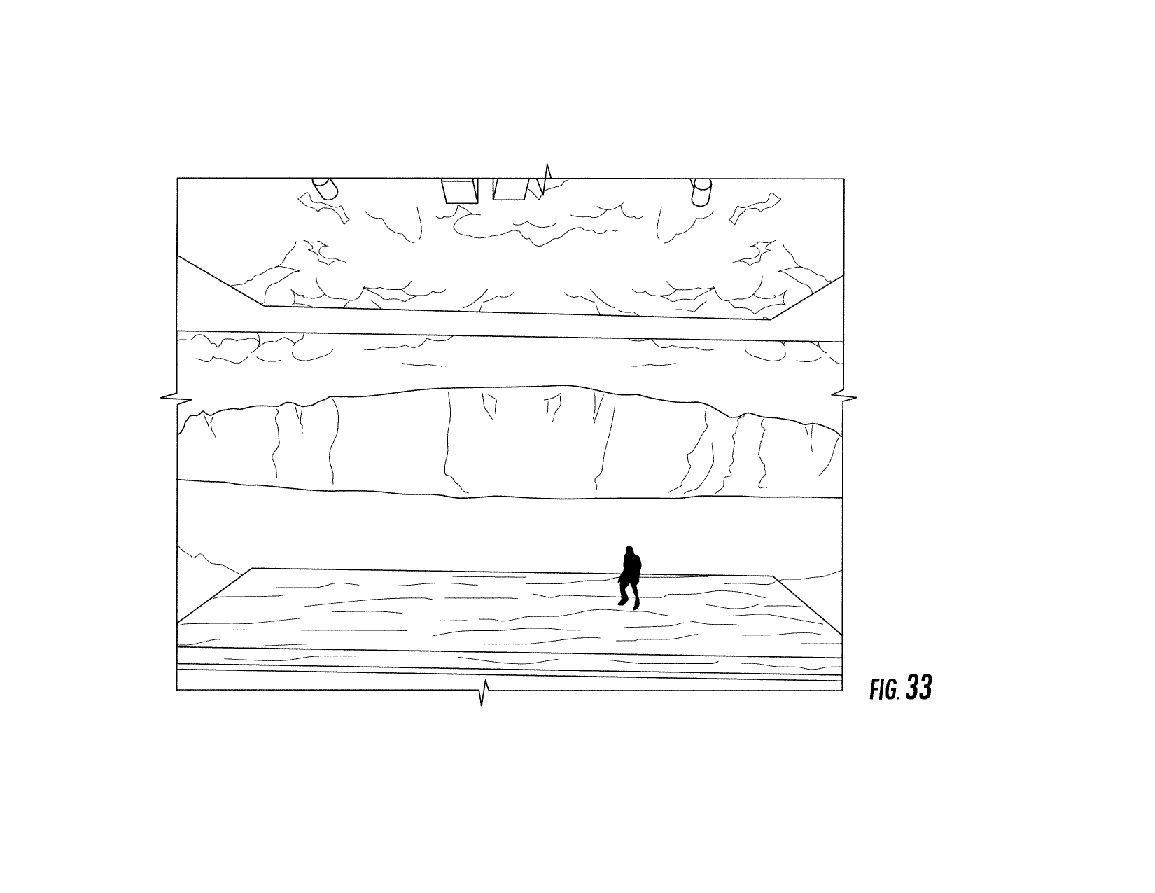

The arena, shown in these photos, also shows use of the bottom or stage screen for both the performers use as a stage for dancing and standing upon and for displaying video thereon. This stage or bottom screen is similar in construction to that depicted in FIGS. 26 through 29. The last two photos (FIGS. 32 and 33) show a performer standing and walking on, respectively, the stage or bottom screen and the video images presented thereon being related to the images shown on the front screens. The third photo (FIG. 32) shows the stage or bottom screen with the performer thereon, seemingly standing in water (as the video is that of a moving water image), with the front screens showing a visual continuation of the video view of water and in the distance, glacial formations, in panorama, with the ceiling or top screen being a further visual continuation, upwardly, of the view of the front screen(s) and showing beautiful, blue sky, above the glow/image of the top of the glacial shots.

### DETAILED DESCRIPTION OF THE DRAWINGS AND THE PREFERRED EMBODIMENT

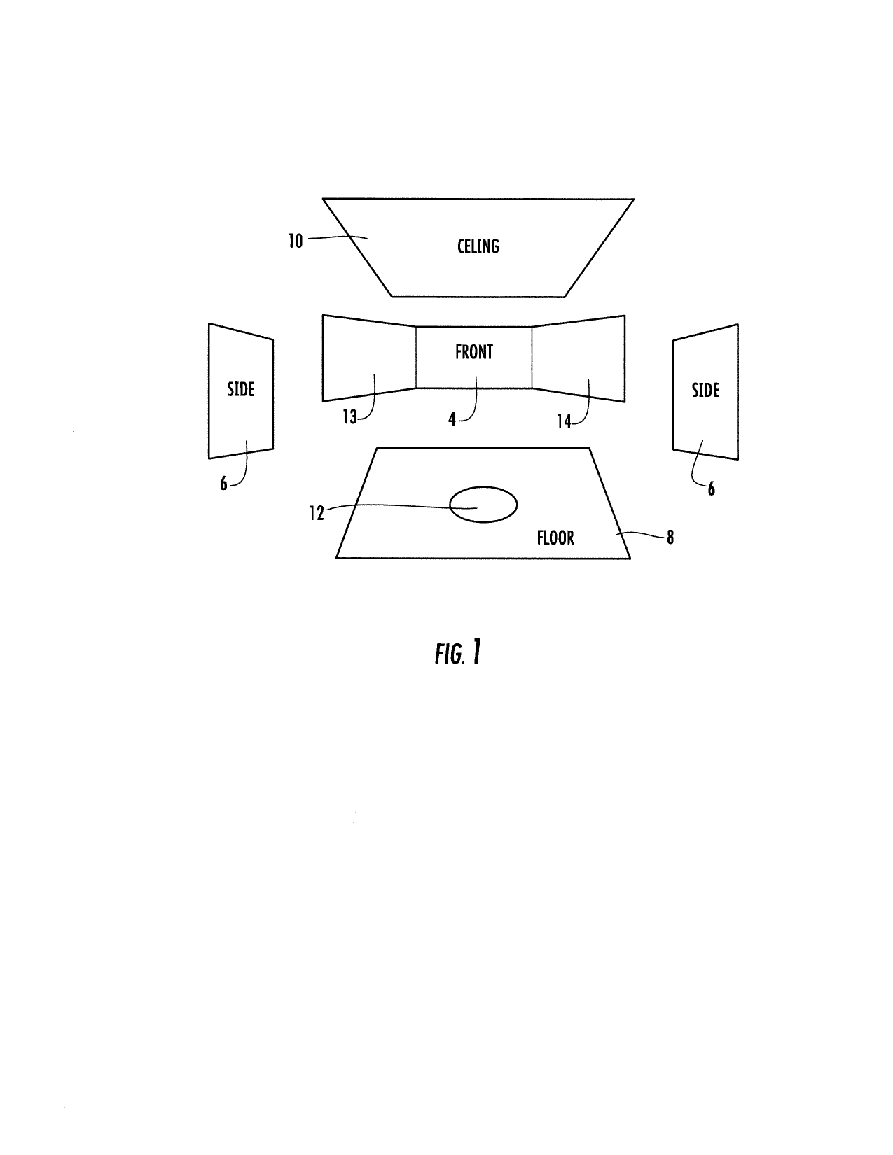

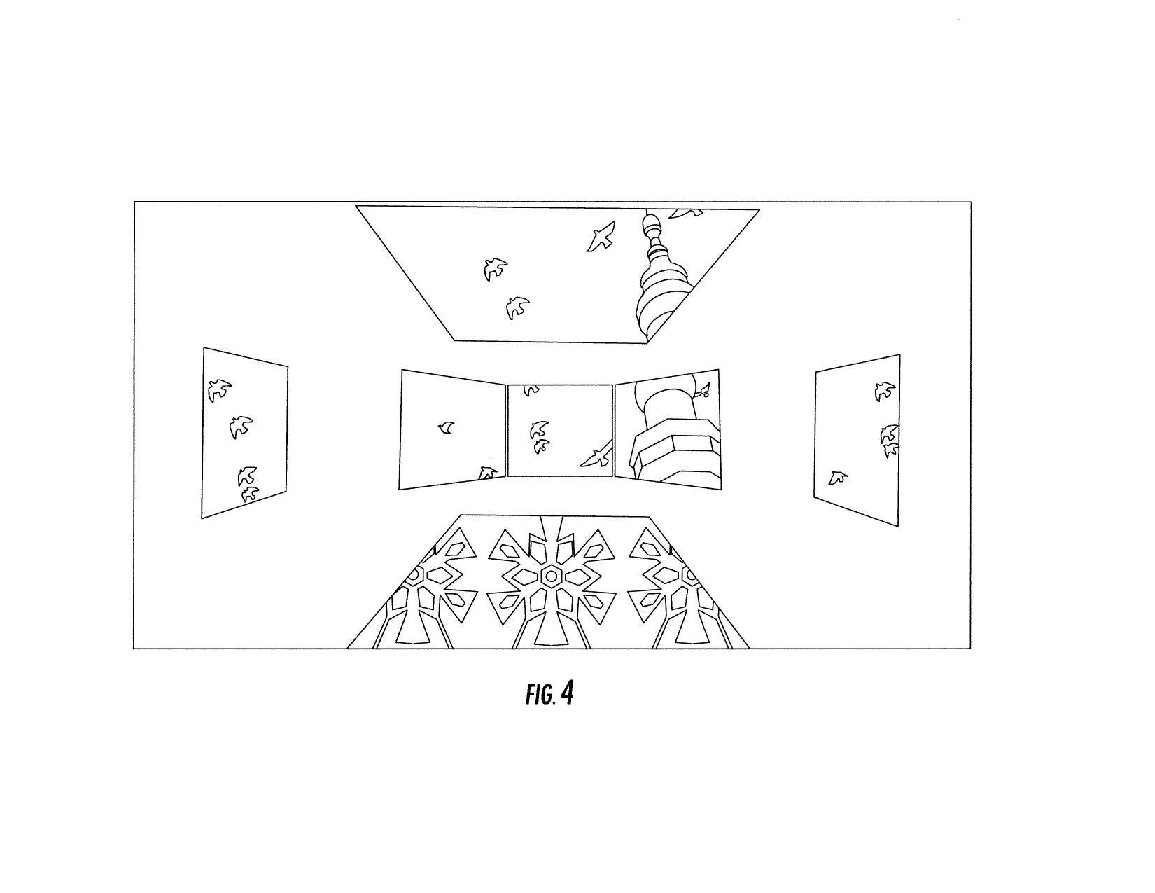

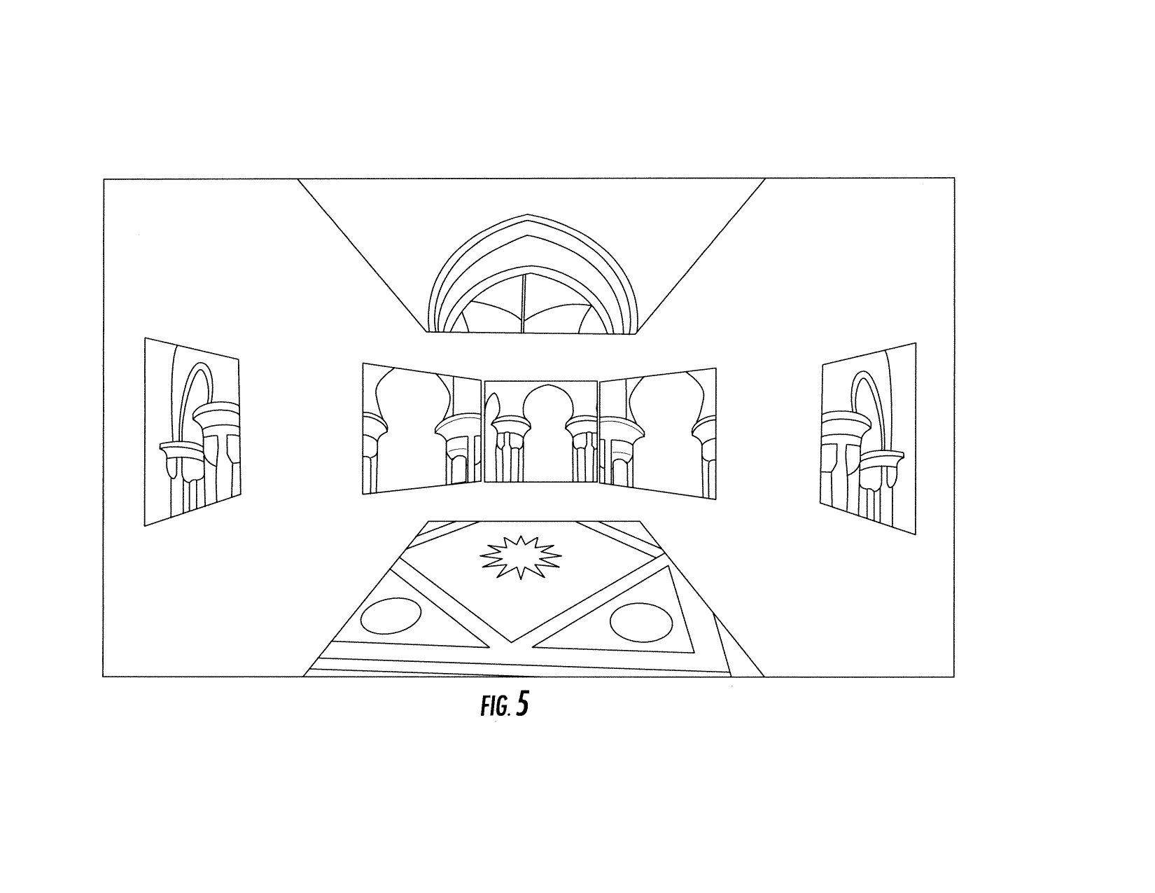

Description will now be given of the invention with reference to the attached FIGS. 1-25. It should be understood that these figures are exemplary in nature and in no way serve to limit the scope of the invention as the invention will be defined by claims, and the scope of the invention will be the scope of the claims, as interpreted by the Courts.

FIG. 1 is a view of the preferred embodiment of the present invention as seen from the perspective of an individual standing at the back of the entertainment room (not the position of a viewer utilizing this invention). The viewer intending to experience the surround video environment provided hereby is expected to sit on a comfortable chair or seat 12 substantially in the center of a room, home theater, entertainment center, or theater. If this invention is to be used in a theatrical setting for large numbers of people simultaneously viewing the moving images on the screens, then seat 12 is intended to represent a set of a viewing seats (one or more spaced in a row with one or more rows) as would be found in a movie theater. Slight tiering can be used between rows so that all eyes are provided with unobstructed views. In front of the viewer(s) seat(s) 12 is a front-located, central image projecting screen 4, which is similar to any monitor, screen, HDTV, rear or front projection image bearing device. It corresponds to an ordinary television or movie screen as normally viewed. However, preferably, connected edge to edge to front screen 4 are two other screens 13 and 14, one on each side of front, center screen 4. These screens 13 and 14 are tilted or canted off of the front planar wall on which the front, center screen 4 is supported, and inwardly cant as the screens project rearwardly, towards the seat(s) 12 projecting slightly off of the vertical plane on the lateral ends of the center screen. The canted yet forwardly located screens thus give the viewer a more complete and life-like, peripheral, frontal viewing experience.

In addition to the three (or more) edge to edge or seemingly seamless screens at the front of the entertainment room, preferably, one or more side screens 6 are located on either or both of the side walls of the seating room. These screens 6, in conjunction with the angled or tilted screens 13 and 14 towards the front of the viewer, give an almost complete peripheral view of the images being seen, creating the experience that the viewer is in the scene of the projected image. Of course, one or more additional screens can be located, extending from the central and front screen to the side screens 6 and, indeed, a single continuous screen can be provided for a seamless peripheral viewing surface. The side screens preferably extend to at least slightly behind the head(s) of the viewer(s). This invention places the screens in locations at which a viewer, sitting in seat or sitting area 12, can see what is happening around him at many lines of sight as if he/she were viewing the same from multiple vantage points. There is no need for the viewer to turn around at any point although rotation of the head slightly will make it easier, of course, to see some of the projected images on the side screens 6.

In the preferred embodiment, there is also located a screen 10 placed on the ceiling above the viewer (preferably flat on the ceiling but this screen could be angled with respect to the overhead ceiling to ease the viewing by the viewer). Also, preferably, another screen 8 is placed on the floor (also preferably flat on the floor but it, too, could be tilted from feet of the viewer upwardly slightly towards the front screen, so as to ease and facilitate a bottom view) with the bottom or floor located screen extending behind, but only necessarily slightly, the rear of the head of the viewer, sitting in seat 2. Ceiling screen 10 preferably and seamlessly extends from almost directly above the front screens 4, 13 and 14, to above the seat 12 where the viewer sits. This gives the viewer a full overhead view of whatever would be seen above the image the viewer is looking at in front of him on the front screen 4. This provides a unique viewing and fully immersive entertainment perspective which a conventional television, even a slightly curved projection screen HDTV screen or monitor/movie screen, and even a cyclorama, does not allow for.

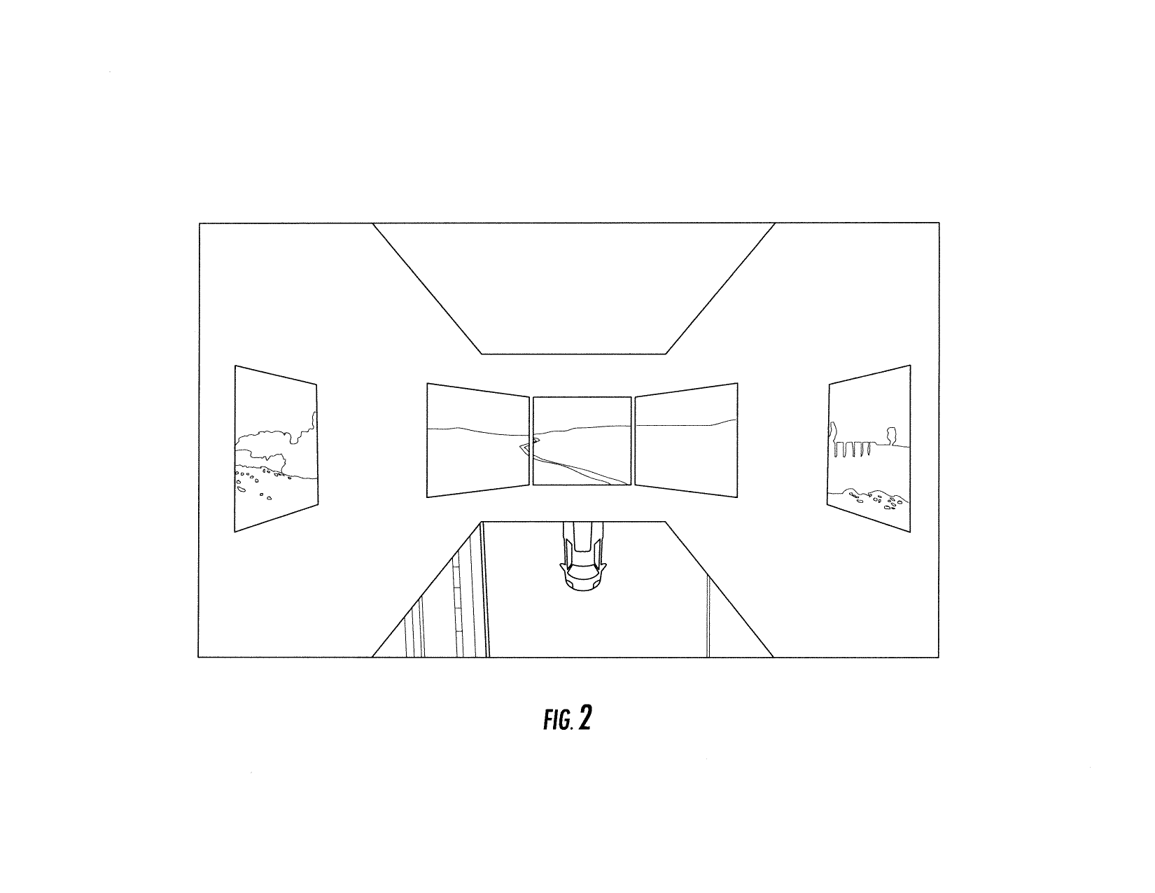

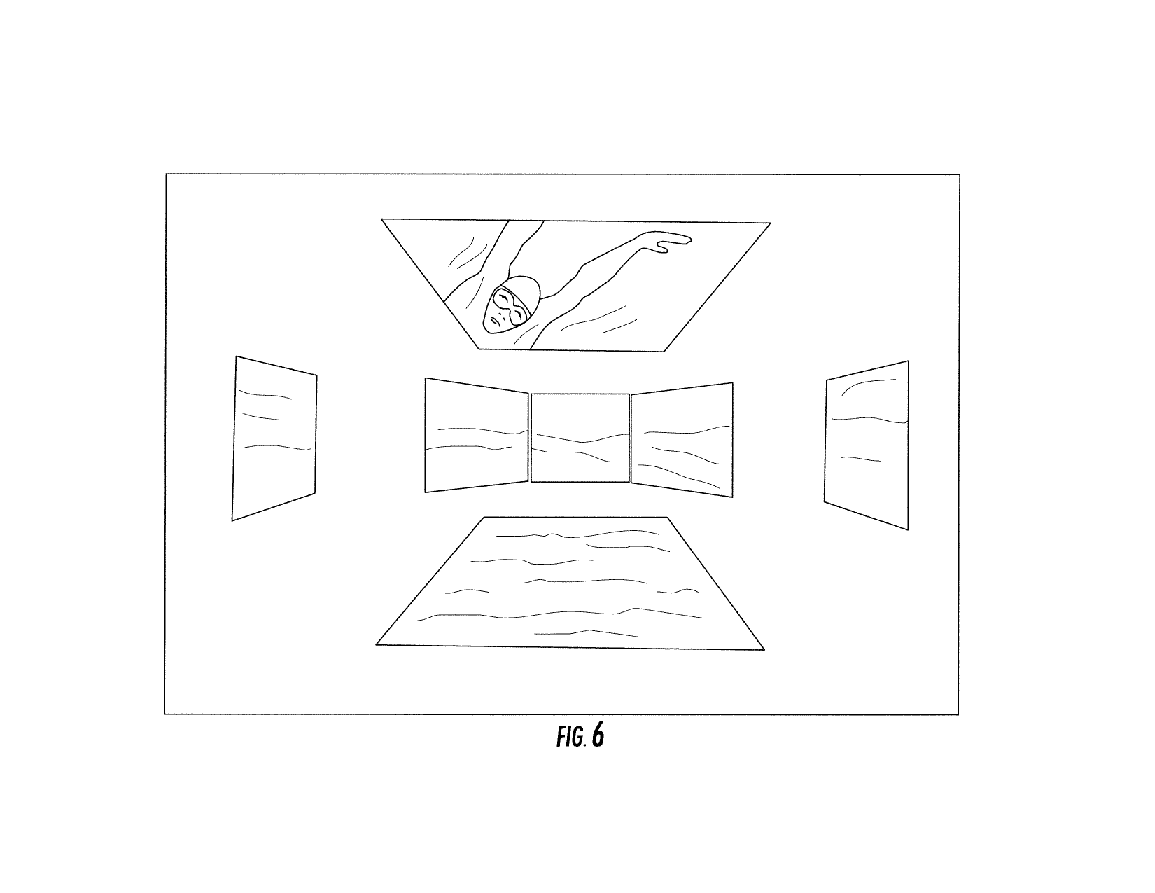

Floor screen 8 is placed beneath (or slightly ahead of) the seat 12 where the viewer sits, and is protected by a translucent or transparent viewing platform, a sheet of scratch-resistant glass, Plexiglas, etc. The viewer ideally sits directly on top of the floor-mounted screen 8 or only slightly behind the rearmost edge of the bottom or floor-mounted screen, giving him or her the opportunity to look down and see what would normally be below the image portrayed on the front screen 4 in front of the viewer. If the projected image on the front screen 4 is of the viewer merely walking in a City, the floor screen 8 may only show the image of the sidewalk or roadway seemingly moving rearwardly as the viewer is seemingly moving forwardly, as viewed on the projected images on the front screen(s) 4. However, if the moving image projected onto the front screen is of the viewer in the sky, as in FIG. 2, or in the water, as in FIG. 6, there are coordinated (spatially and realistically) moving images to be seen below the viewer's vantage point (the earth or reef and fish below, respectively, for example) which would not be seen on a conventional television or movie screen. A fully visually immersive experience is provided.

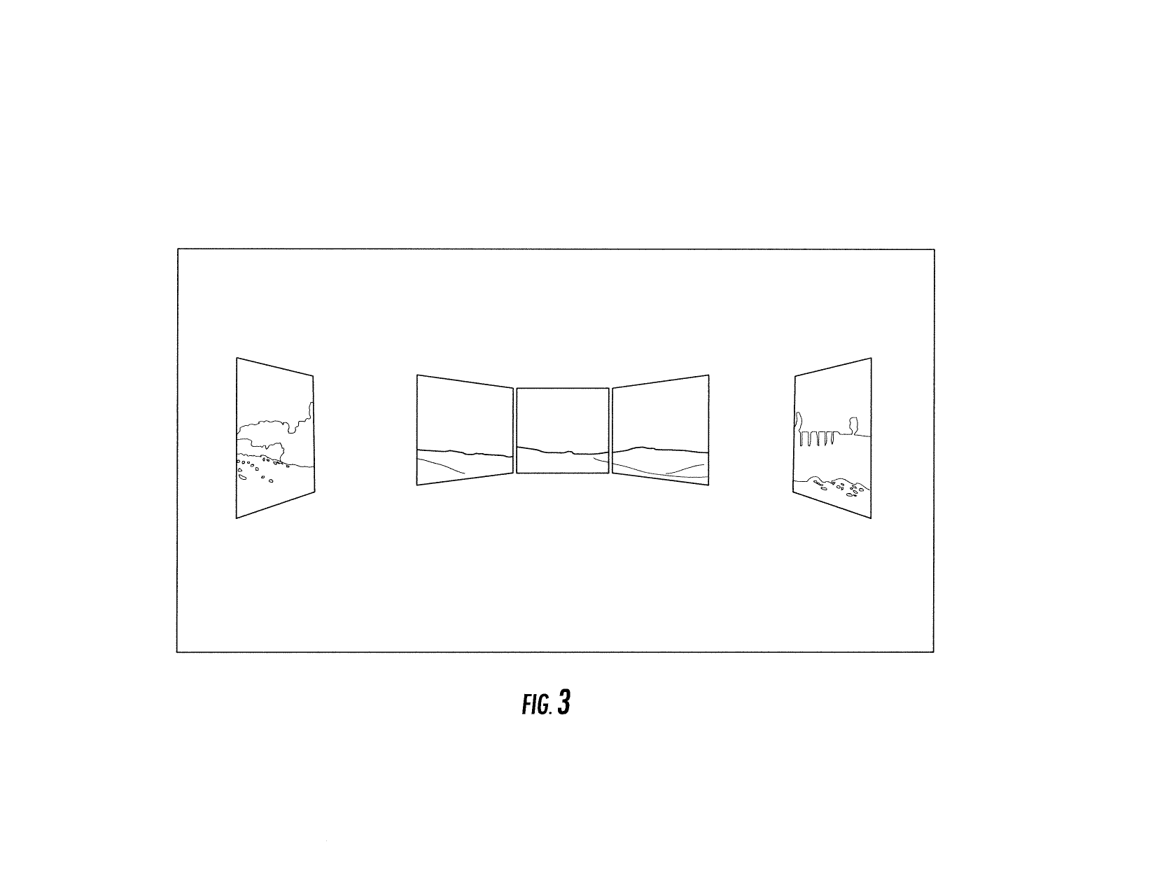

FIGS. 2-7 show examples of the present invention in use, with images shown on all seven screens. All are viewed from the perspective of the viewer sitting at seat location 12, experiencing images on the three front screens 4, 13 and 14, side screens 6 to either or both sides, and ceiling screen 10 above and floor screen 8 below the viewer. As can be seen in FIGS. 3 and 7, if the images to be viewed are only located on a preselected number of the screens around the viewer, the other screens may appear blank. This is determined by the producer/director (which could include the viewer if playing, for example, a video game) depending upon the experience to be presented and the degree of realism to be maintained.

Of course, important to the overall experience is the capture and coordination of the video images. These can be obtained by traditional techniques and equipment. Preferably, for example, a ring of outwardly facing, horizontally directed cameras will be used for the front, and side screens, while an upwardly and downwardly directed camera will be used for capturing images for the ceiling or above screen and the bottom or below screen images. Computer synchronization of images shown on the front central screen 4 with the angled screens 13 and 14 and the side screens 6, as well as the ceiling screen 10 and/or bottom or floor screen 8 is important to the overall immersive effect. This is a function of the artist or director/manufacturer of the experience and believed to be fully understood by those of skill in the art relating to providing a video entertaining experience. As previously mentioned, the overall experience is enhanced if coupled to a set of speakers (or headphones worn by the user(s)) which are located around the theater environment and, further, the system is enhanced in realistic effect if the audio pans and is synchronized along with the images depicted and shown on the various screens.

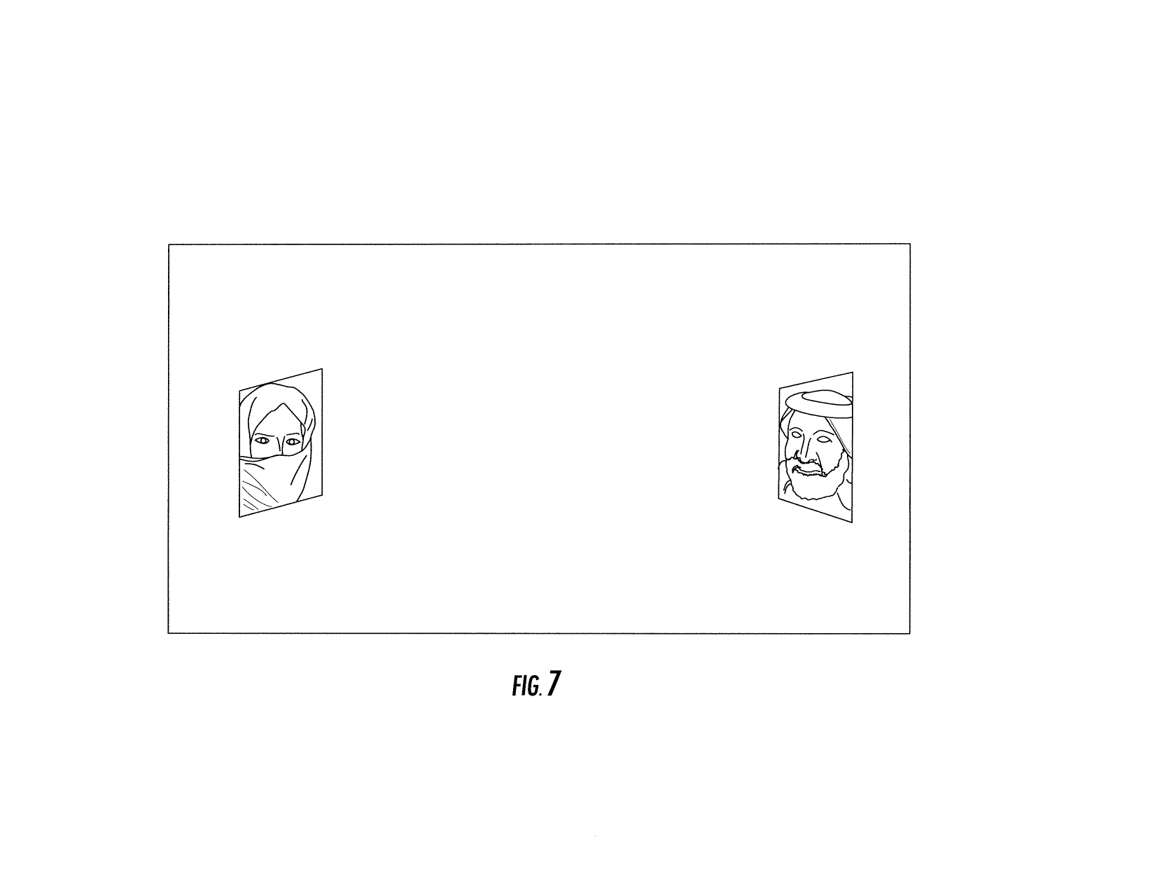

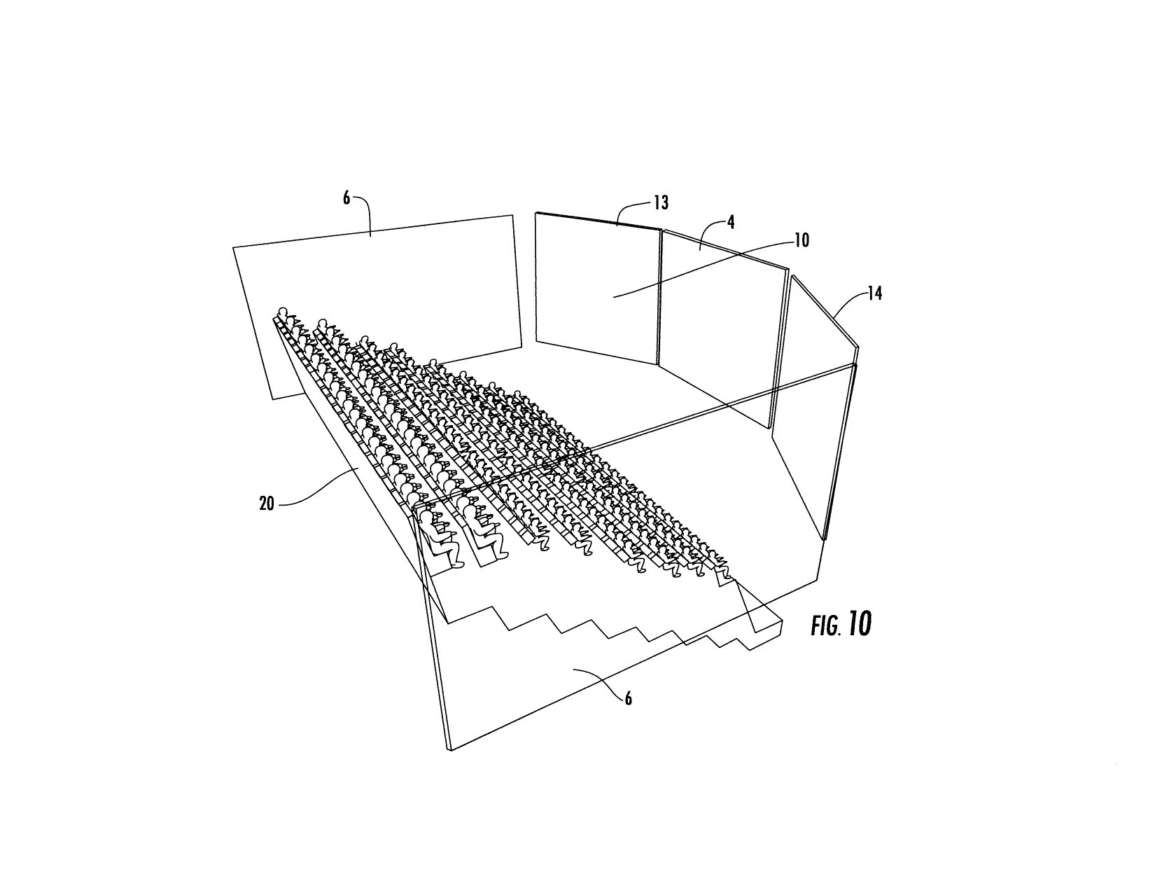

FIG. 8 shows an overhead view of the preferred embodiment of the present invention. The screens surround viewing area 20, and each screen is provided with its own projection means (a simple rearward projector, computer input, etc. Seven total screens are provided in the preferred embodiment: central front-located screen 4 and two outer front-located screens 13 and 14, ceiling screen 10, side screens 6, and floor screen 8 (not seen in this view). This embodiment depicts the present invention being utilized in theatrical format. FIG. 10 is a side elevational view of FIG. 8, depicting the preferred number of screens.

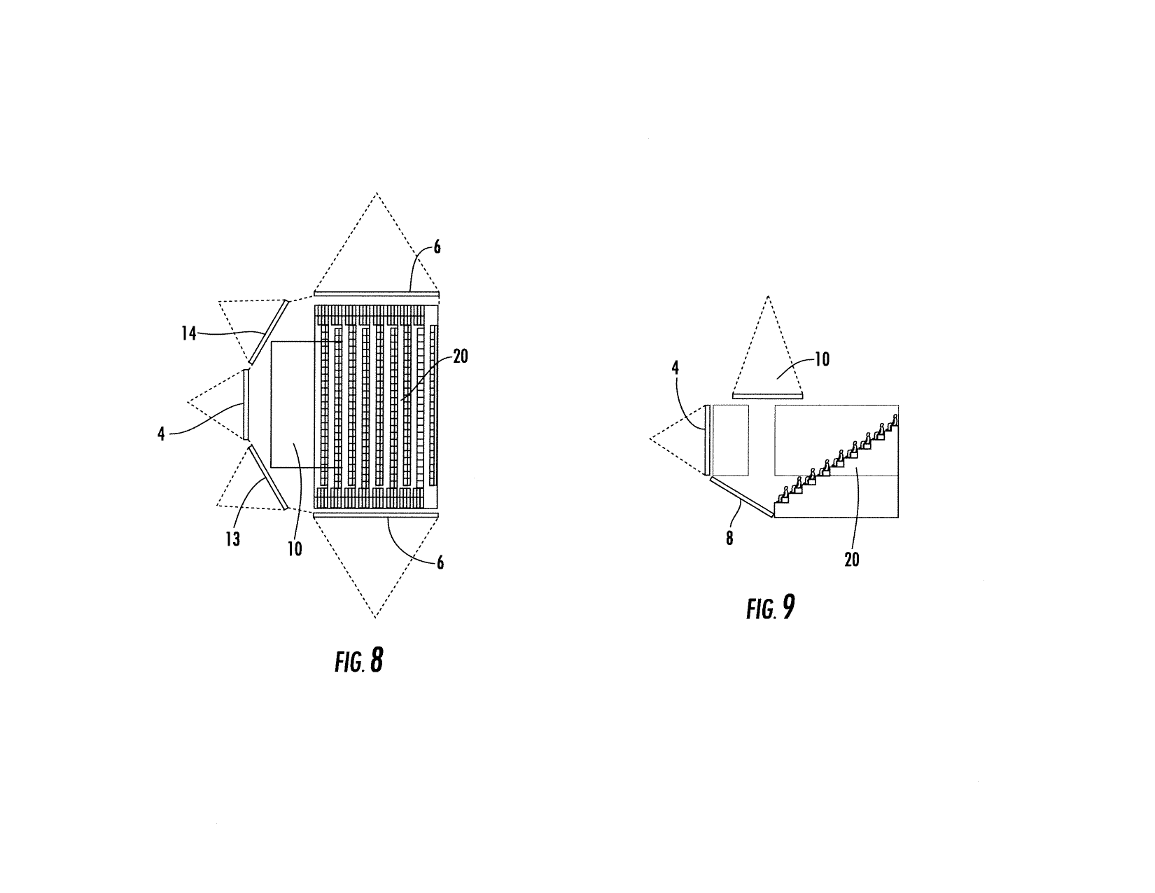

FIG. 9 is a side perspective view of FIG. 8, showing viewing area 20. Floor screen 8 is shown, and, as is shown in one possible embodiment, it is titled at an upward angle toward the viewing area 20, extending upwardly from the feet of the viewers towards the front screen(s). This is provided to improve viewing of floor screen 8 to add to the video-immersive overall experience of the present invention. Like the outer front-located screens 13 and 14, which are preferably angled rearwardly yet towards side screens 6, floor screen 8 can be titled upward toward front screen 4 so as to create a more complete, and near-contiguous viewing screen area. This is designed to provide the feel to a viewer of actually being in the scene projected onto the viewing screens. In one embodiment of the present invention, the bottom or floor-like mounted screens extends from a distal edge just below or near the bottom of the front screen to a proximal edge near to the feet of the closest of the viewers located on the tiered rows of seats in a theater. The preferred embodiment suggests that the center of the tiered rows of seats in a theater having the present invention correspond to the approximate vertical center of the front screen. The lower located tiers of seats will be below the vertical center of the front screen but will have more of the bottom screen visible to it for a fully immersive effect while the center row of tiered rows and above will see more of the front screens, without tilting their necks, to maximum advantage and, yet, will see slightly lesser of the tilted bottom, floor mounted screen. This is shown in FIG. 9.

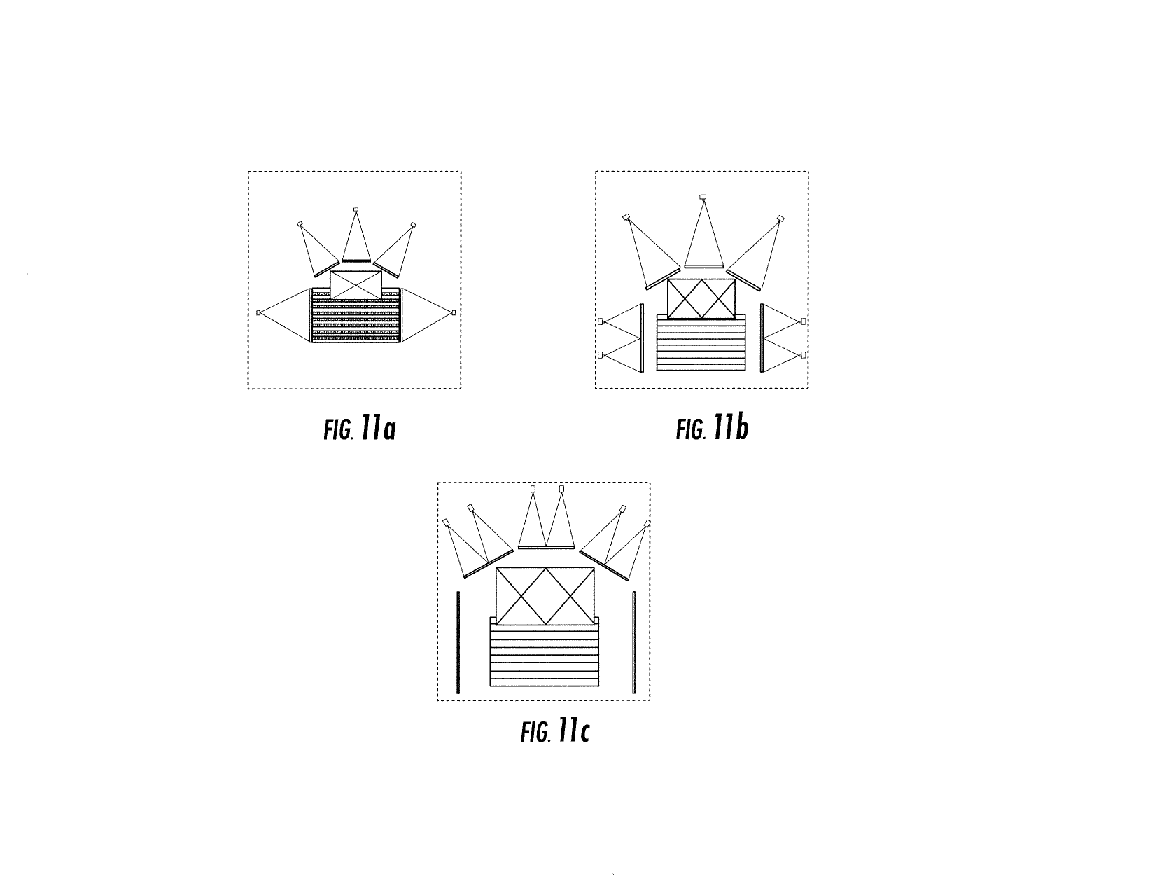

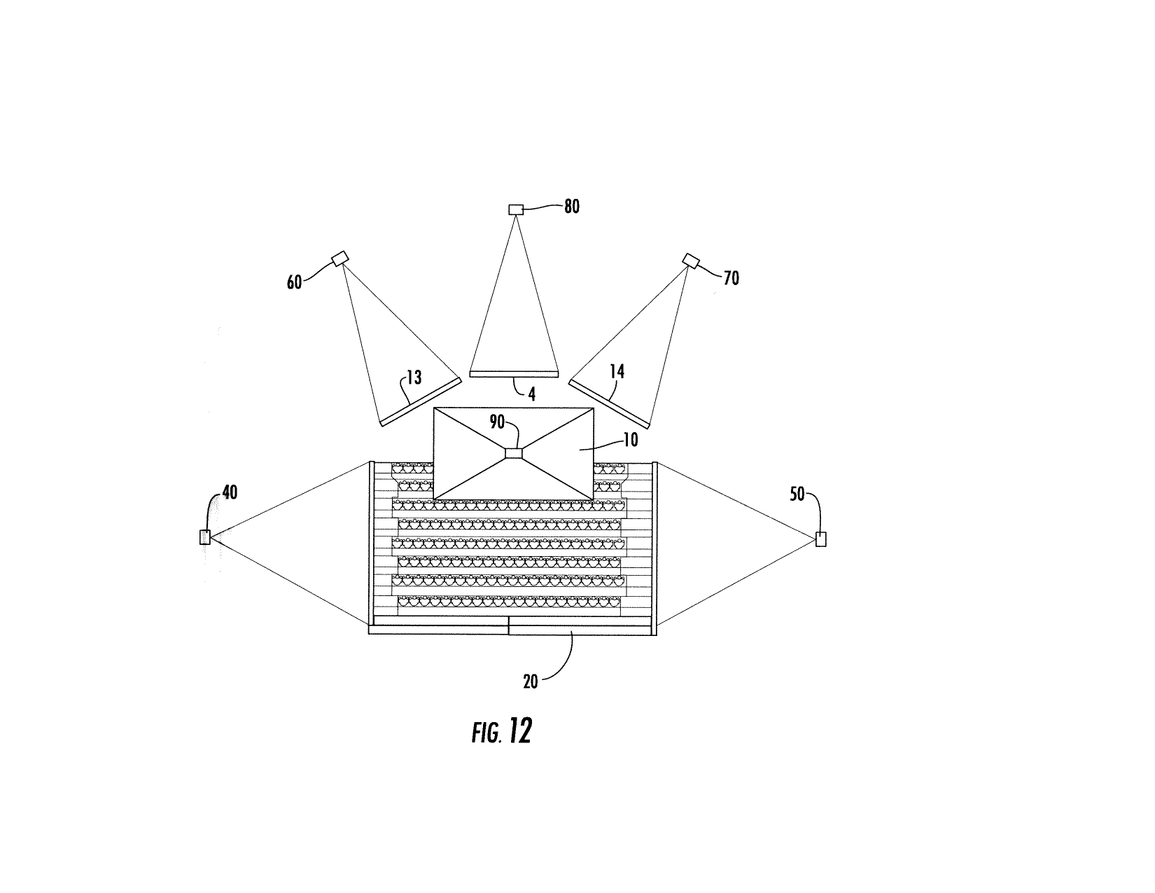

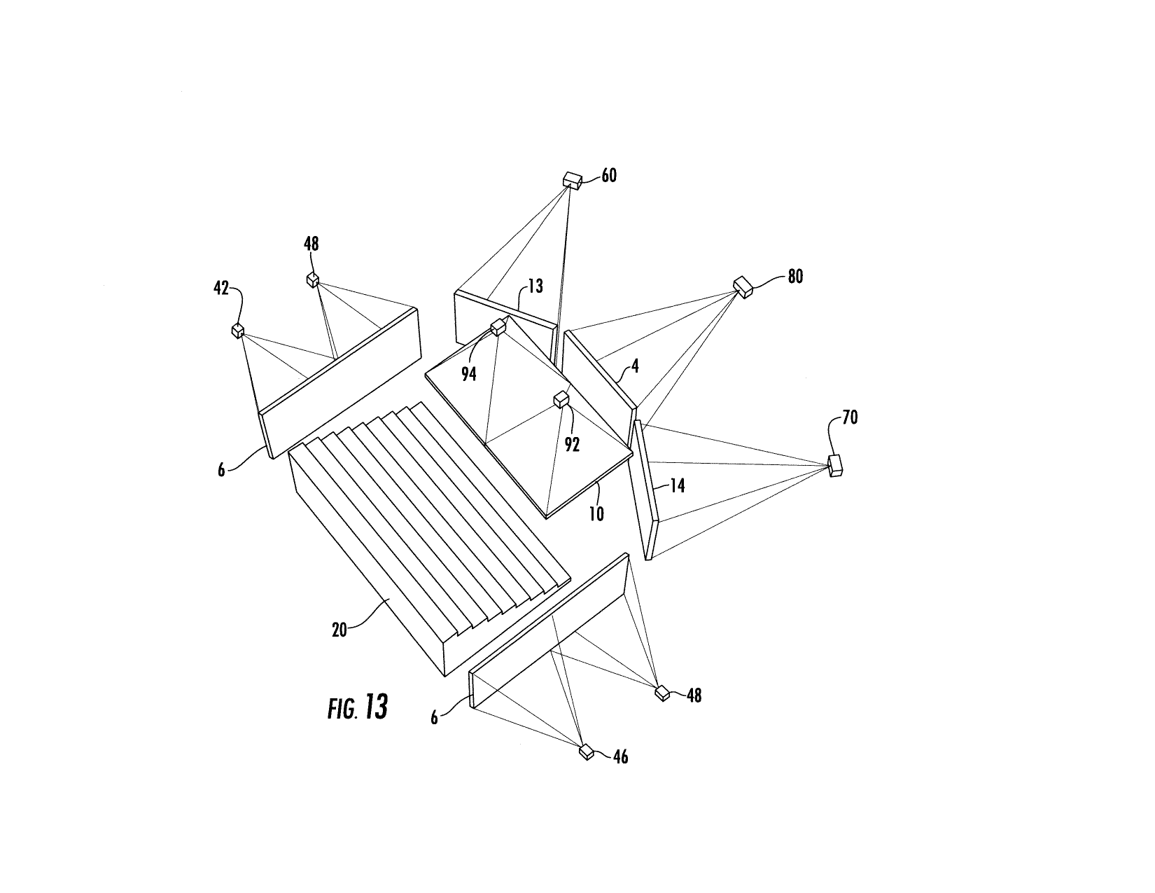

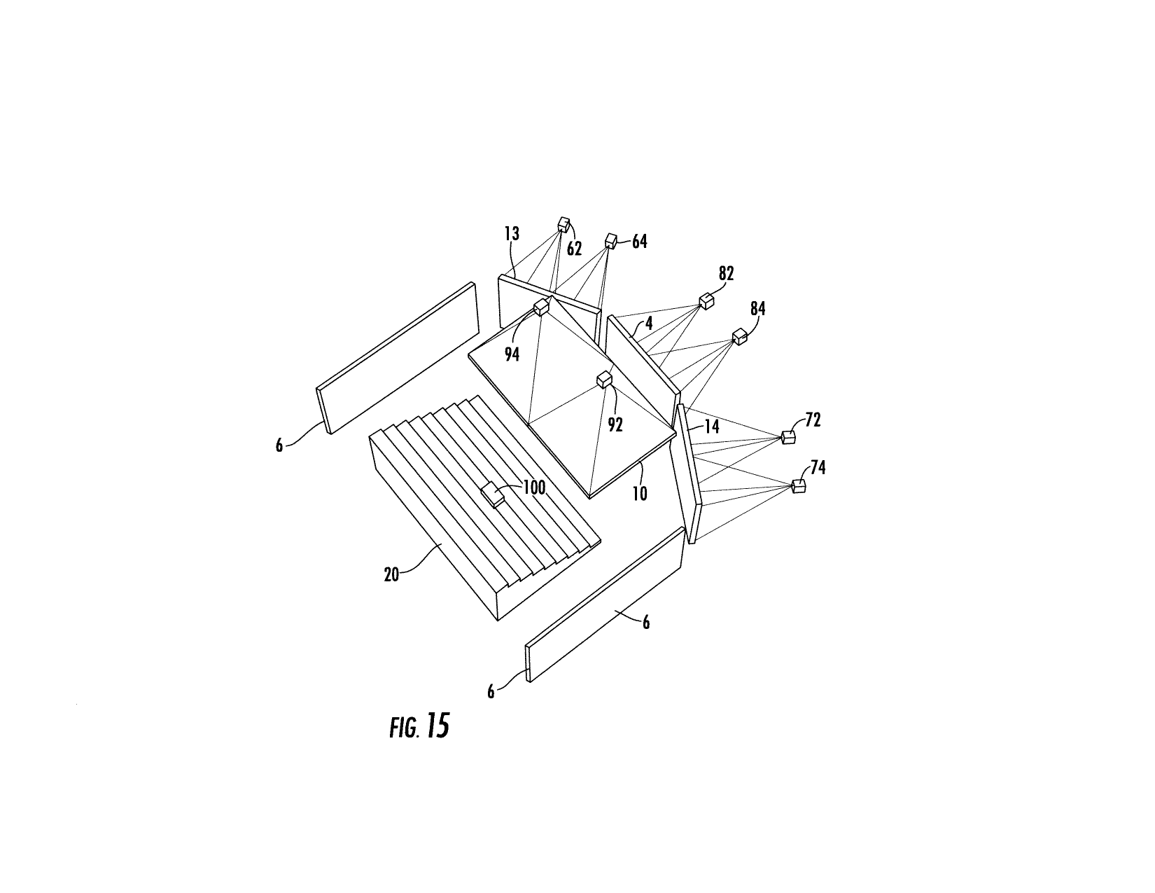

FIGS. 11a-11c depict alternate embodiments of the projection means for the viewing screens. FIG. 12 is an enlarged top view of FIG. 11a, showing the preferred embodiment of one projector located on the rear side of each viewing screen, thereby projecting images onto the screens to be seen by viewers on the opposite side. Rear projection screen technology may enhance the experience. Relatedly, the screens and the images projected thereon can be of 3-dimensional type and that, too, can be manipulated by the image creator to advantage, again, to enhance the immersive experience. Projectors 40 and 50 sit behind each of side screens 6; projector 90 sits above ceiling screen 10; projector 80 sits behind center front-located screen 4; and projectors 60 and 70 sit behind each of outer front-located screens 13 and 14. Each projector is capable of providing a different image to its associated screen than the others, which allows the images which would be depicted in all directions surrounding a viewer to be shown simultaneously. FIG. 14 is a side elevational view of FIG. 12.

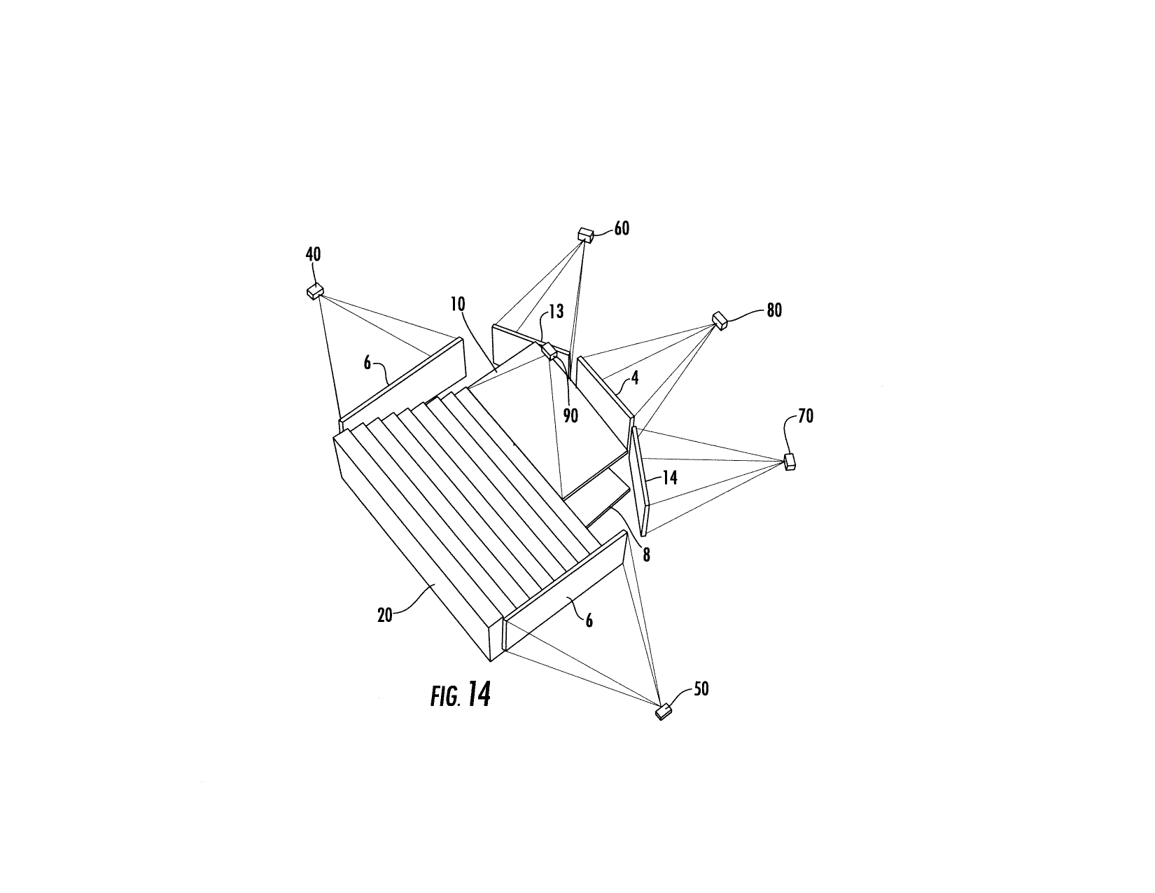

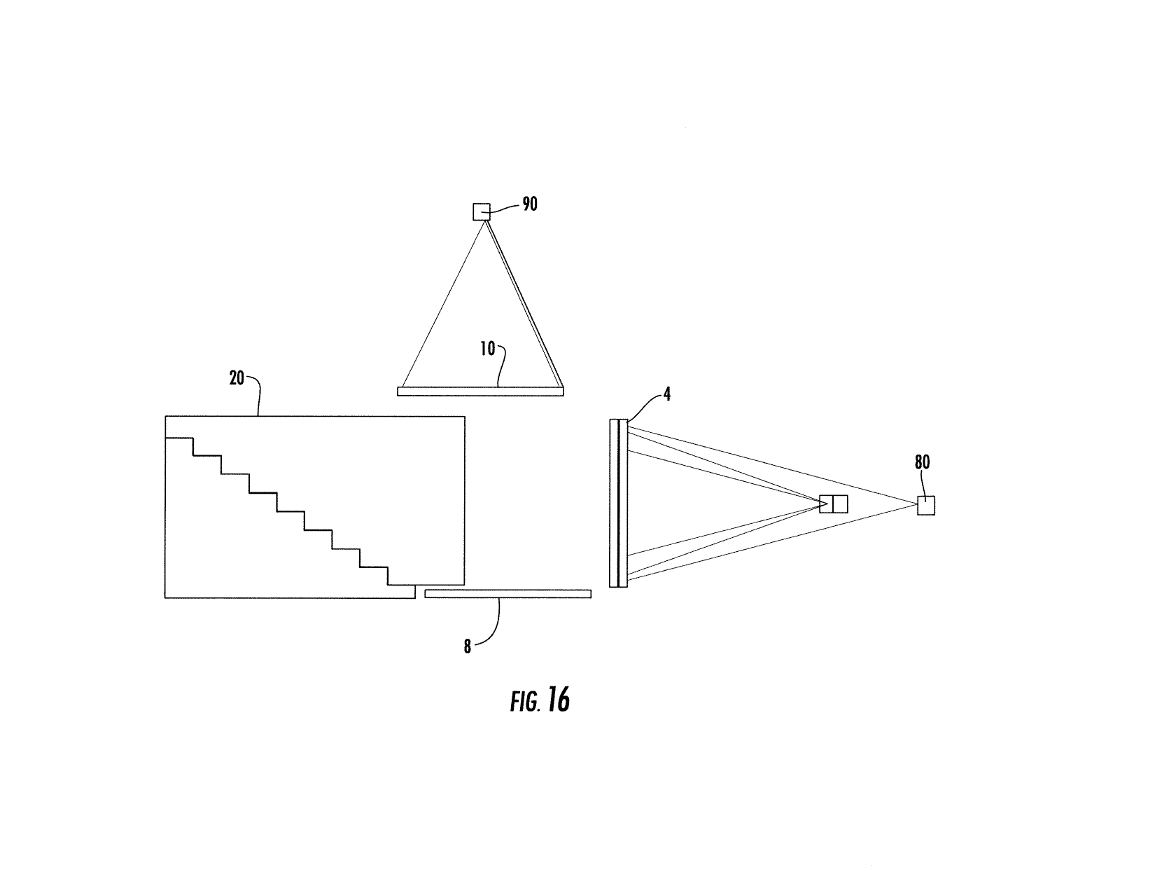

FIG. 13 is an enlarged side elevational view of FIG. 11b depicting an alternate embodiment of the projector set-up for the viewing screens. This embodiment depicts multiple projectors 42, 44, 46, and 48 used for side screens 6, and multiple projectors 92 and 94 for ceiling screen 10. The multiple-projector embodiment allows multiple images to be displayed on the same screen, or additionally, allows the viewing screens to be increased in length without affecting the distance behind which the projector must sit for proper focus. FIG. 15 is an enlarged side elevational view of FIG. 11c

depicting yet another alternate embodiment of the projector set-up for the viewing screens. Here, a front projector 100 is used for side screens 6, which sits atop viewing area 20, at an angle away from, and thus not blocking, ceiling screen 10. This embodiment also includes multiple projectors 82 and 84 used for center front screens 4, projectors 62 and 64 and 72 and 74 for each of outer and/or canted front screens 13 and 14.

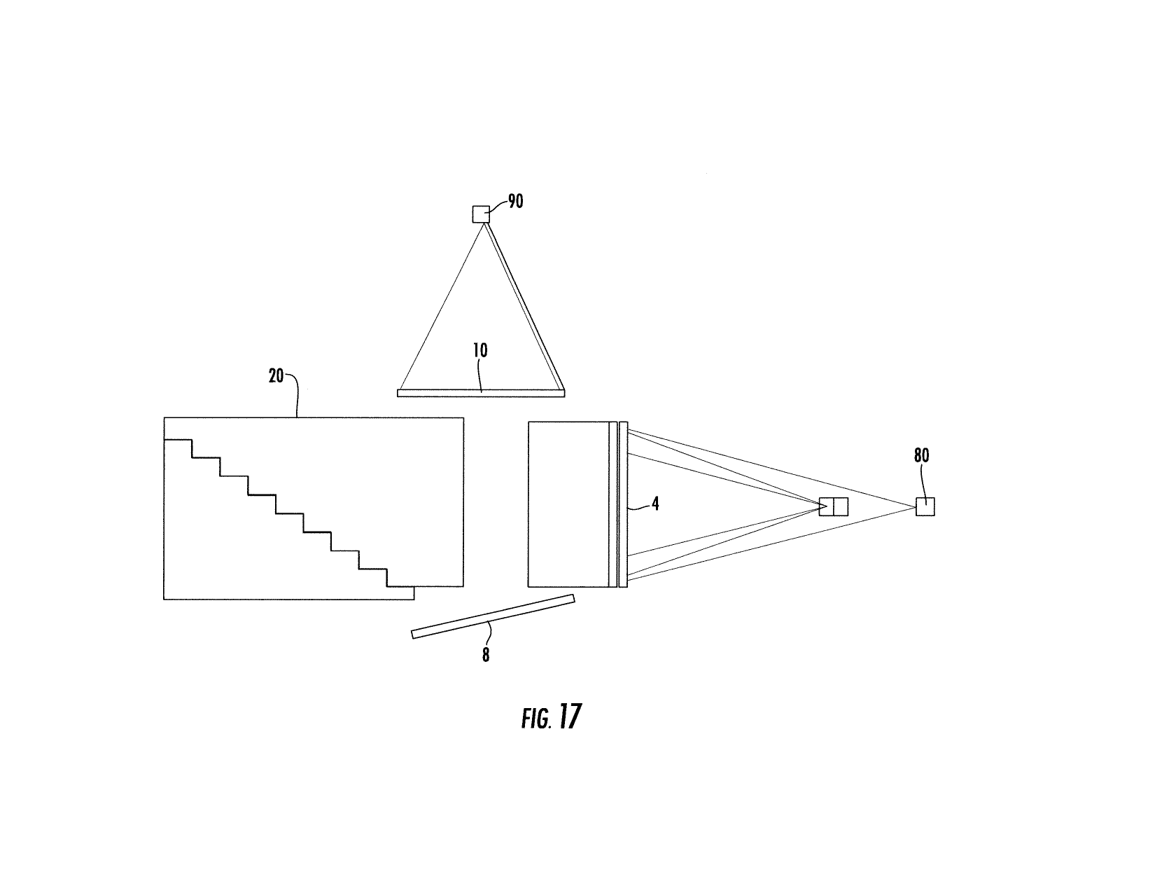

FIGS. 16 and 17 are both side perspective views of present invention, showing floor screen 8 in a flat position facing upward (FIG. 16) and also in an angled and tilted position facing toward the viewers (FIG. 17). The angling of floor screen 8 is an additional embodiment which is intended to add to the overall viewing experience. By tilting the top of floor screen 8 upwardly ad towards the bottom of center front-located screen 4, the gap between projected images is narrowed to further depict an almost contiguous and immersive realistic video image.

Referring back to FIG. 1, yet another embodiment of the invention is shown. The Figure can also be considered to show a single monitor or screen which has been divided into individual sections or segments, i.e., a main section 4, side sections 13 and 14 to the main section; side walls 6 and a ceiling section 10 and floor section 8. These sections are shown in perspective views and would show the video imagery to the viewer even though he/she is not located in the actual central seat position 12 on the floor. Stated differently, the single rectangular screen or monitor of a home entertainment system will show the various video imagery in the designated areas to provide an immersive and exciting moving effect. Each section, 4, 13, 14, 6, 8 and 10, will display the spatially coordinated video to that preferably shown on the front (slightly above center but horizontally centered) segment. The sides of the single monitor 6 will show the video imagery corresponding, spatially, to the side views of that shown on the front segment 4, on the same video screen of the home entertainment system. the top trapezoidal and bottom, also trapezoidal sections, 10 and 8, respectively, of the flat monitor for the home entertainment system, will depict and show the video images which spatially correspond to that depicted in the front section or segment 4. In this manner, even a single, flat video screen or monitor can provide a somewhat immersive, highly thrilling entertainment effect—by sectioning the viewable surface into areas, each of which will show or depict the spatially related video image to that shown on the front, central segment or section 4 of the overall viewable area.

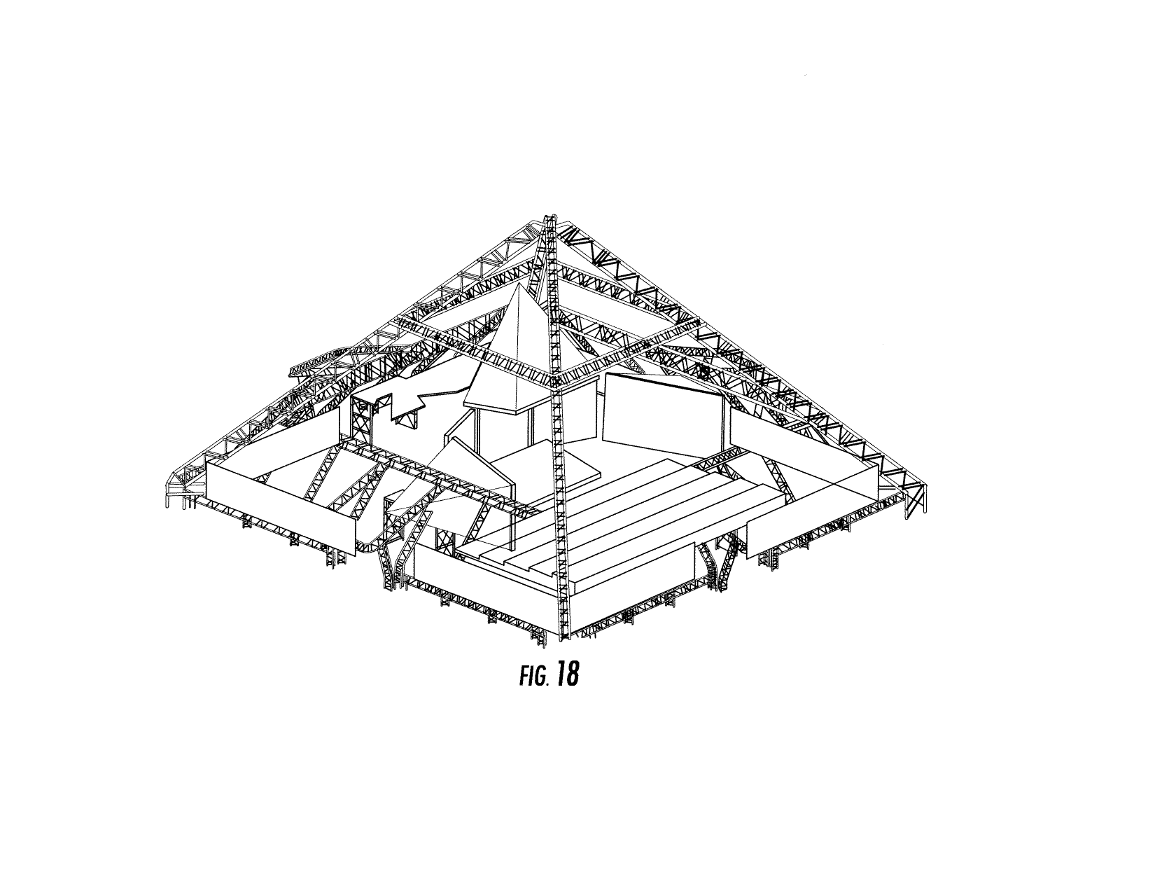

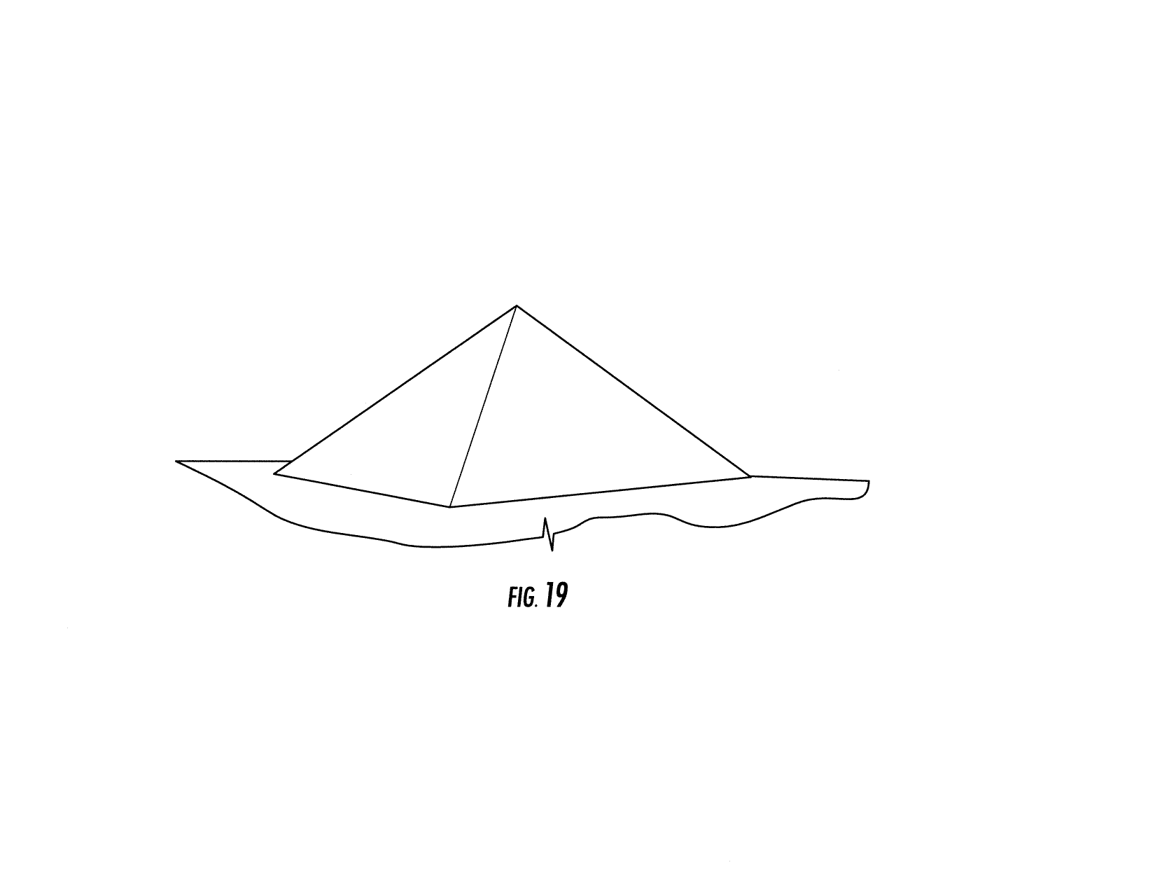

FIG. 18 shows a hollowed out version of one embodiment of a theater containing the present invention, with the theater shaped as a pyramid. As can be seen, all screens and projectors are positioned inside the theater, as is a viewing area. FIG. 19 is an outside view of the theater depicted in FIG. 18, shaped as a pyramid.

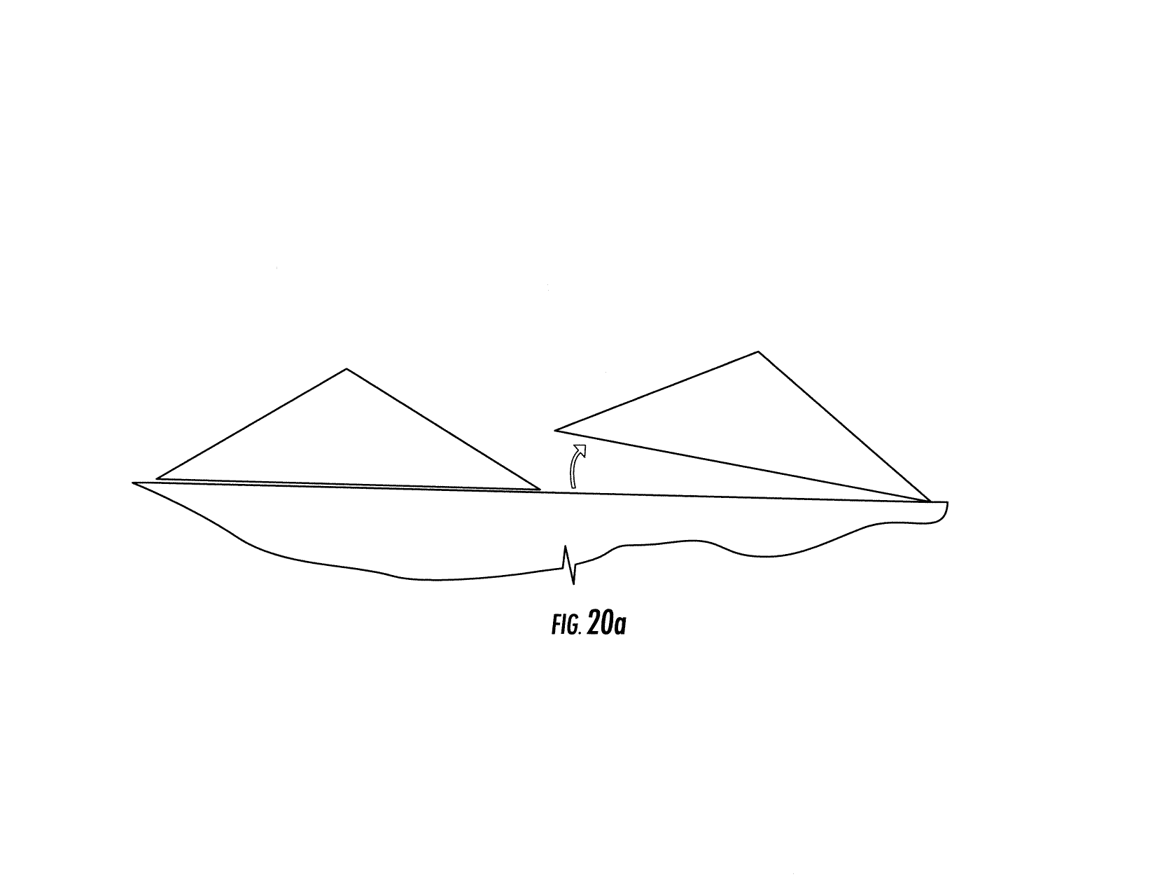

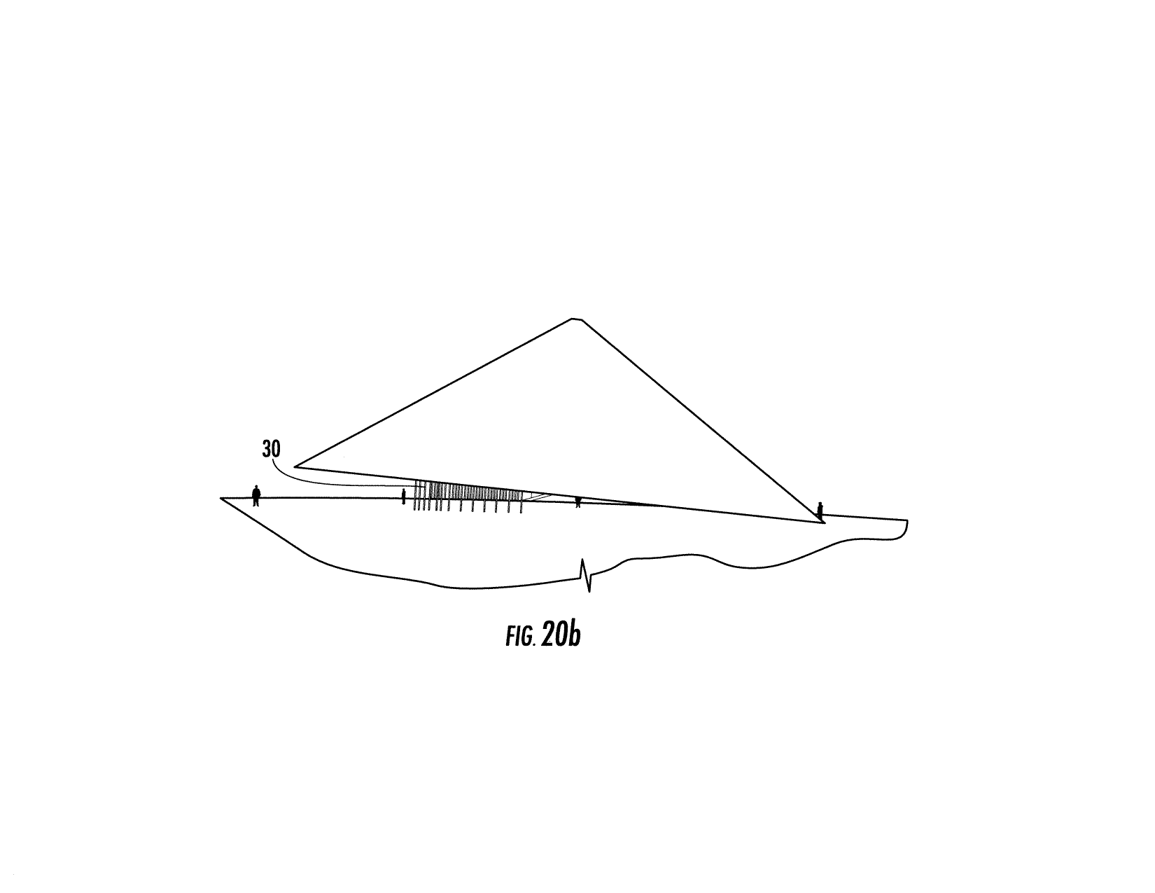

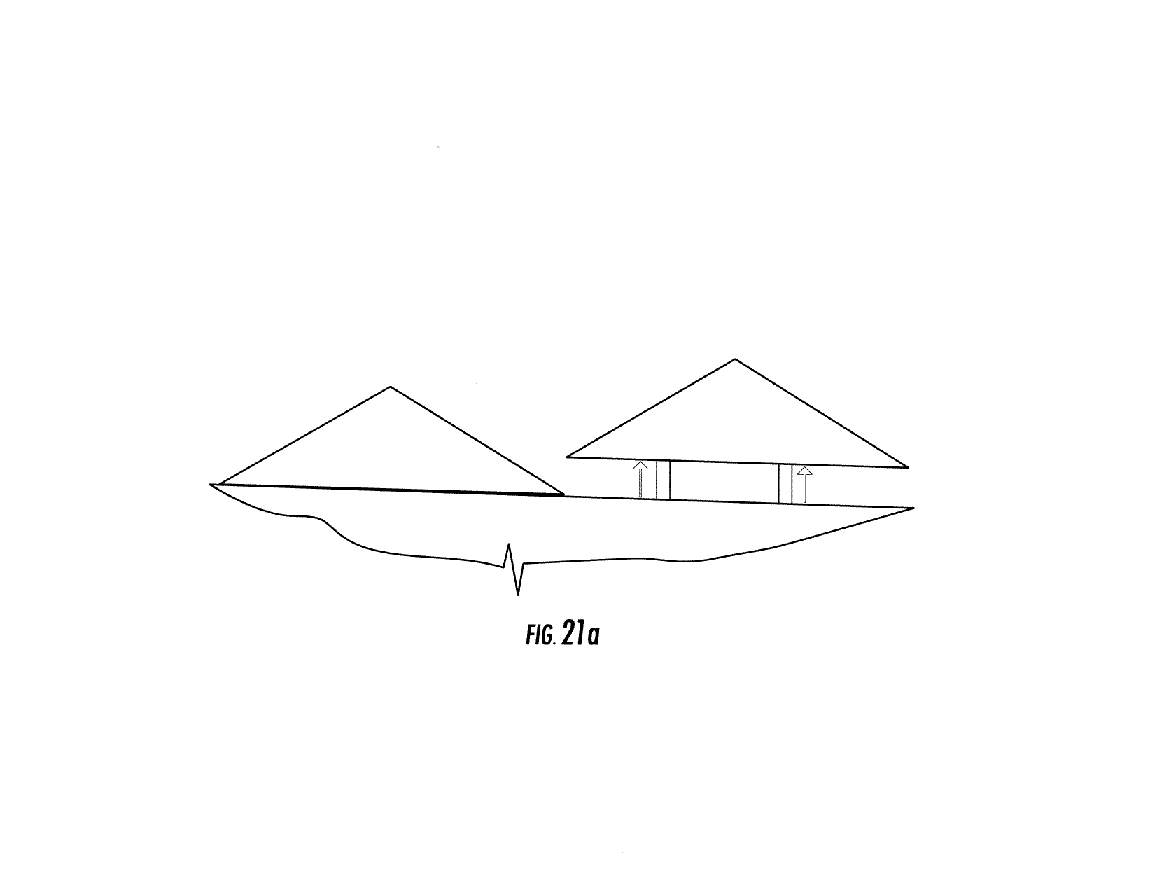

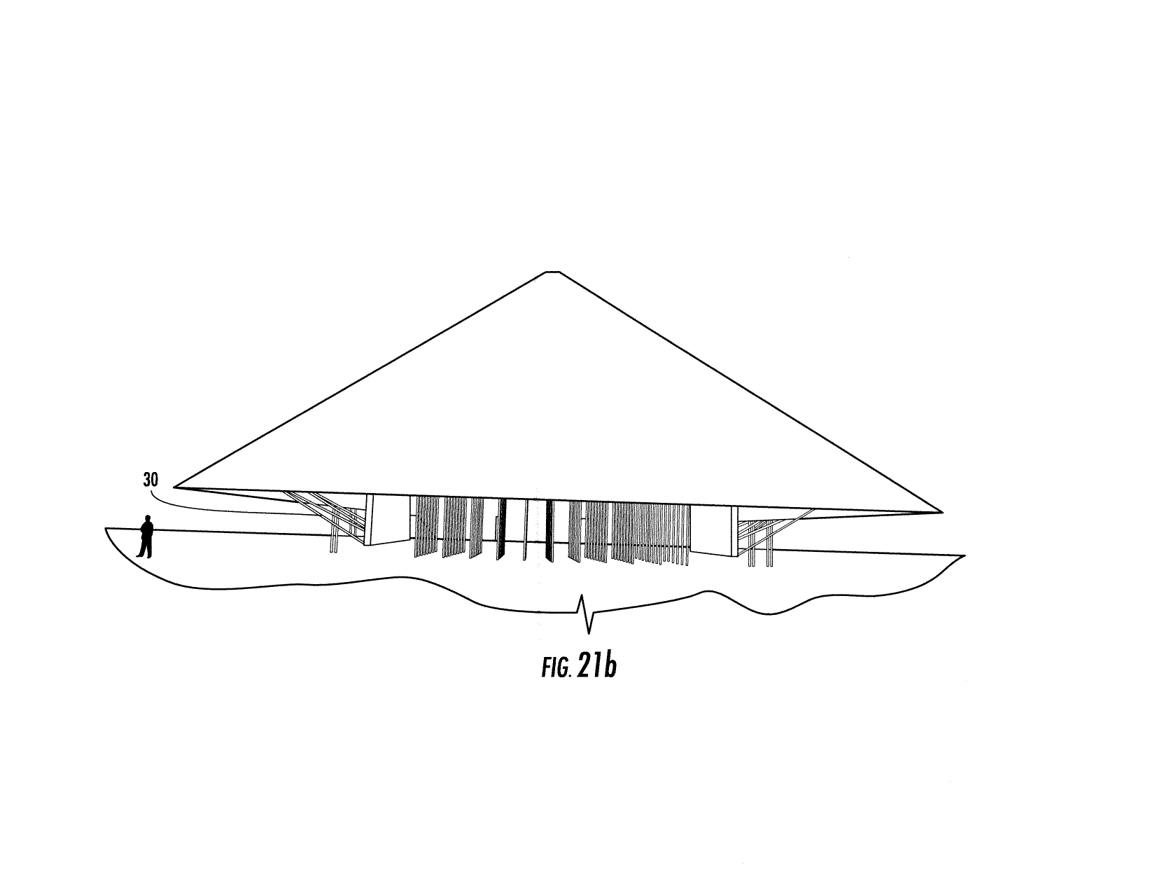

FIGS. 20a-20b and 21a-21b show two additional embodiments of the present invention which add to the overall experience of a viewer. Here it is disclosed that the theaters, which are designed to house the multi-screen experience provided for by the present invention, can also be designed with hydraulic lifts 30 to either tilt or raise the entire structure. This presents an additional element of “virtual reality” to the viewing experience. These hydraulic lifts 30 are specially implanted into the structure of the aforementioned theaters, in a similar way that movable hinges are placed on the viewing seats in “virtual reality” rides. These Figures only depict the hydraulic lifts as implemented in a pyramidal-shaped theater, but it is taught that any shaped theater can be equipped with such machinery.

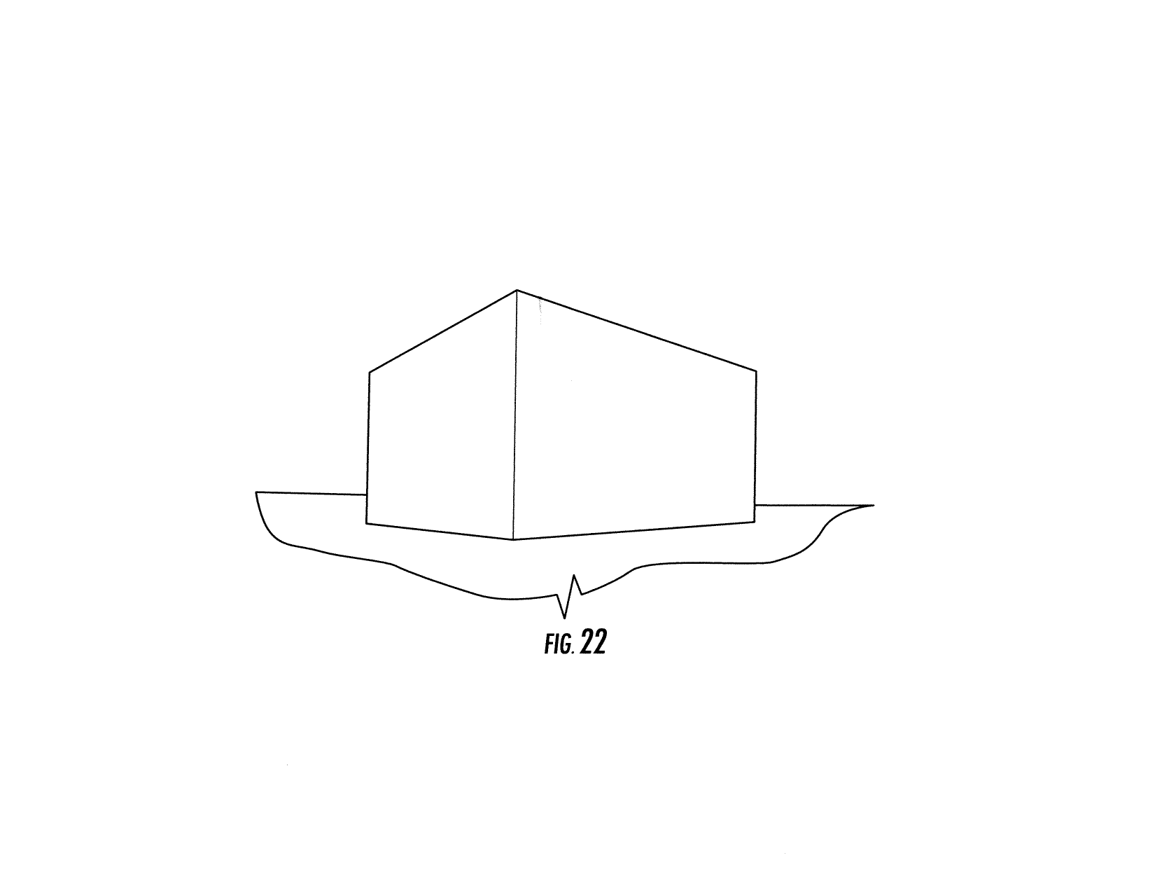

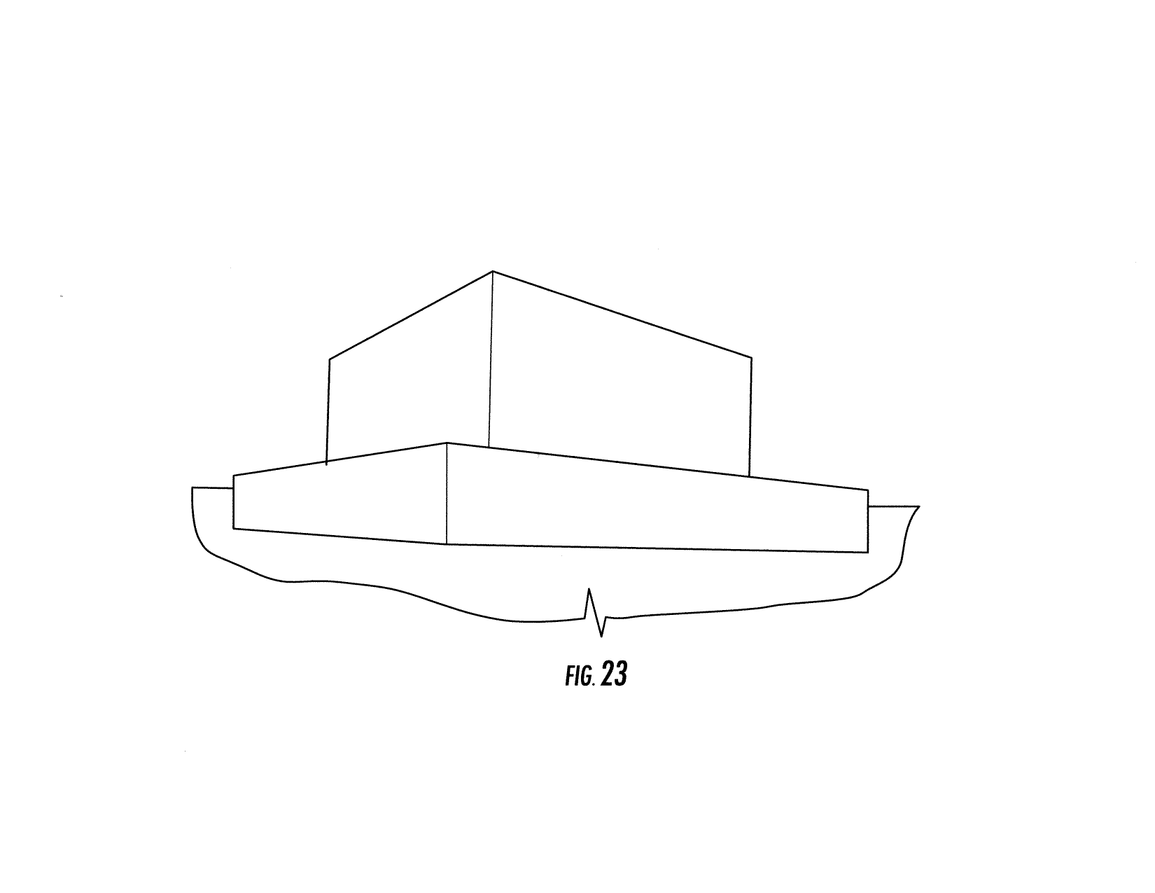

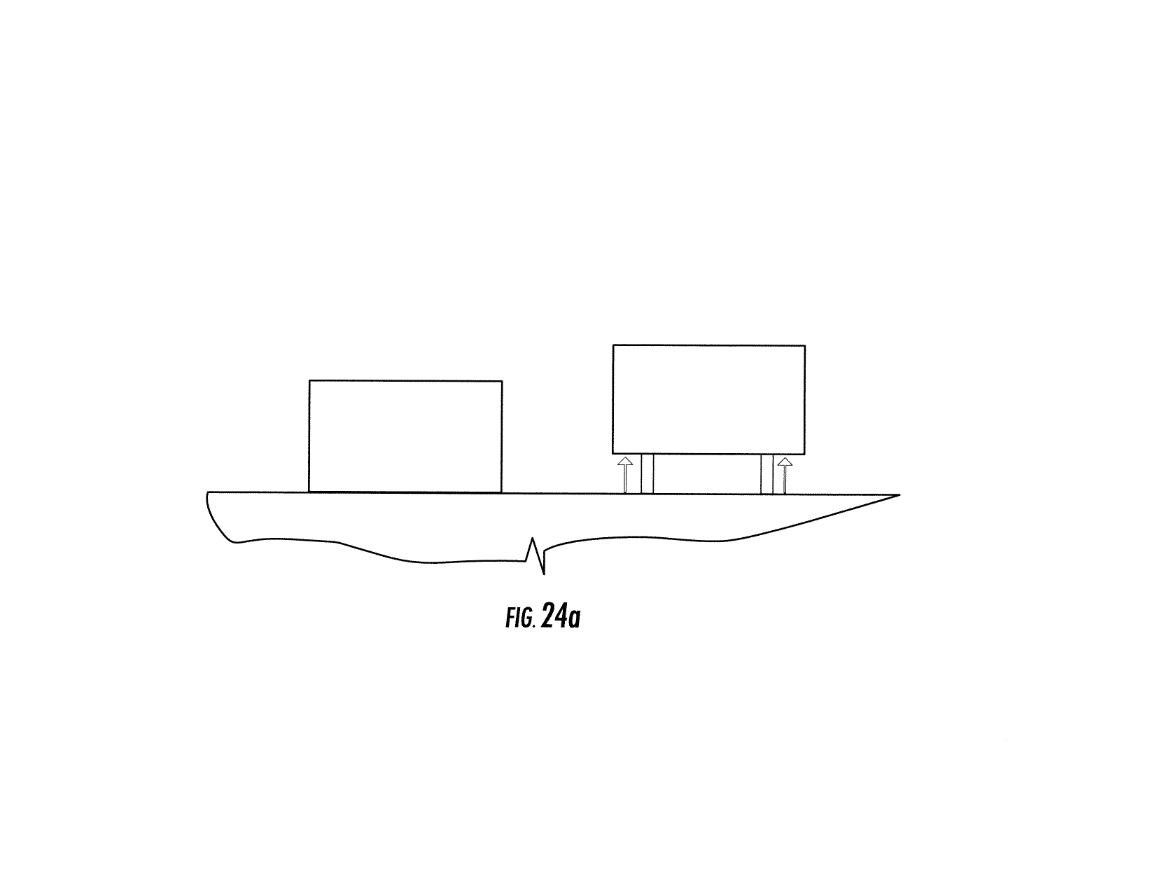

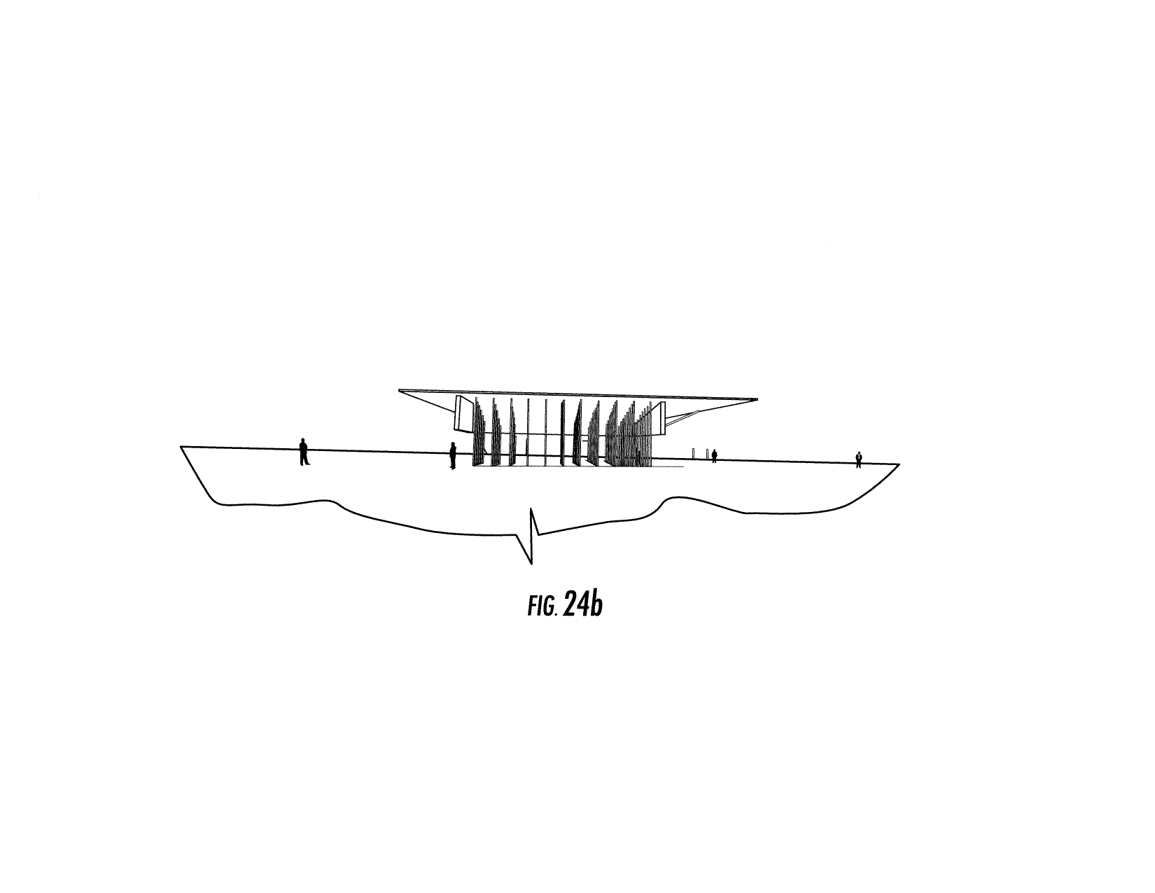

FIG. 22 shows an alternative embodiment of the disclosed theater shaped as a cube. It too is designed to house the multi-screen experience and viewing stage. FIG. 23 depicts the use of the hydraulic lifts 30 as described above in the tilting of the cube-shaped theater. FIG. 24 is a depiction of the use of hydraulic lifts 30 in the raising and lowering of the cube-shaped theater. Finally, FIG. 25 is another alternate embodiment, with the theater shaped as a half-sphere. All elements and embodiments of the previously described theaters also pertain to that depicted in FIG. 25. Hydraulic lifts could be secured between the ground and one or more sections of the theater's above ground structure. As shown in the drawings, the theater, whether in the shape of a pyramid, cube, half-sphere, etc. could be entirely lifted upwardly by the hydraulic mechanisms or the theatrical structure's roof could be lifted by the hydraulic mechanisms acting on an edge, corner, etc.

Furthermore, as mentioned, the overall immersive entertainment effect is believed to be enhanced by coordinating the visual experience provided by the multi-screen environment with the surround sound, now available or further coordinated with the various images projected onto the screens. While it is believed that the immersive effect is best achieved with the displayed images on the various screens being spatially related to one another, other variations are possible, too. So, for example, if a swimmer in a pool is depicted on the front screens as if he is swimming longitudinally across the pool, with or without other swimmers in a race, then the top ceiling view could be a set of video images from a camera located above the swimming pool, showing all swimmers and the floor-located screen could depict the swimmer from the view of a camera located below the surface of the water. The side views could be images of the crowd or could be images of the adjacent swimmer(s) to the single swimmer of primary interest, e.g., the leader or a swimmer from a particular team or country. The images shown on the screens would likely be different from one another and as one screen changes perspective or view (selected by a live director, for example) the other images displayed on the other screens could either simultaneously switch to other predetermined spatially related displayed images or stay the same or switch to other viewpoints, depending upon location of various camera feeds.

The construction of the housing of the present invention can utilize lightweight yet structurally strong materials. Other shapes, beyond those described above can be employed. For example, the housing can be a pyramidal shape sitting upon a square base (when viewed from above) or a pyramid sitting upon a square base whose edges are at a maximum where the pyramid is in contact with the top of the base and at a minimum where the base contacts the ground, etc. The housing or roofing for the theater can also be in the form of multiple stacked parallelepiped shapes with the top or uppermost shape being a cube.

FIG. 26 is a perspective view of a large stage 100 for a performer(s) at a concert, for example, the stage also serving as a bottom screen for the viewers in the audience to see still or moving video images, along with the front screen(s) and/or the ceiling or top screen(s). The supporting trusses 102 and vertical support legs 104 are shown along one side 106 of the stage/bottom screen.

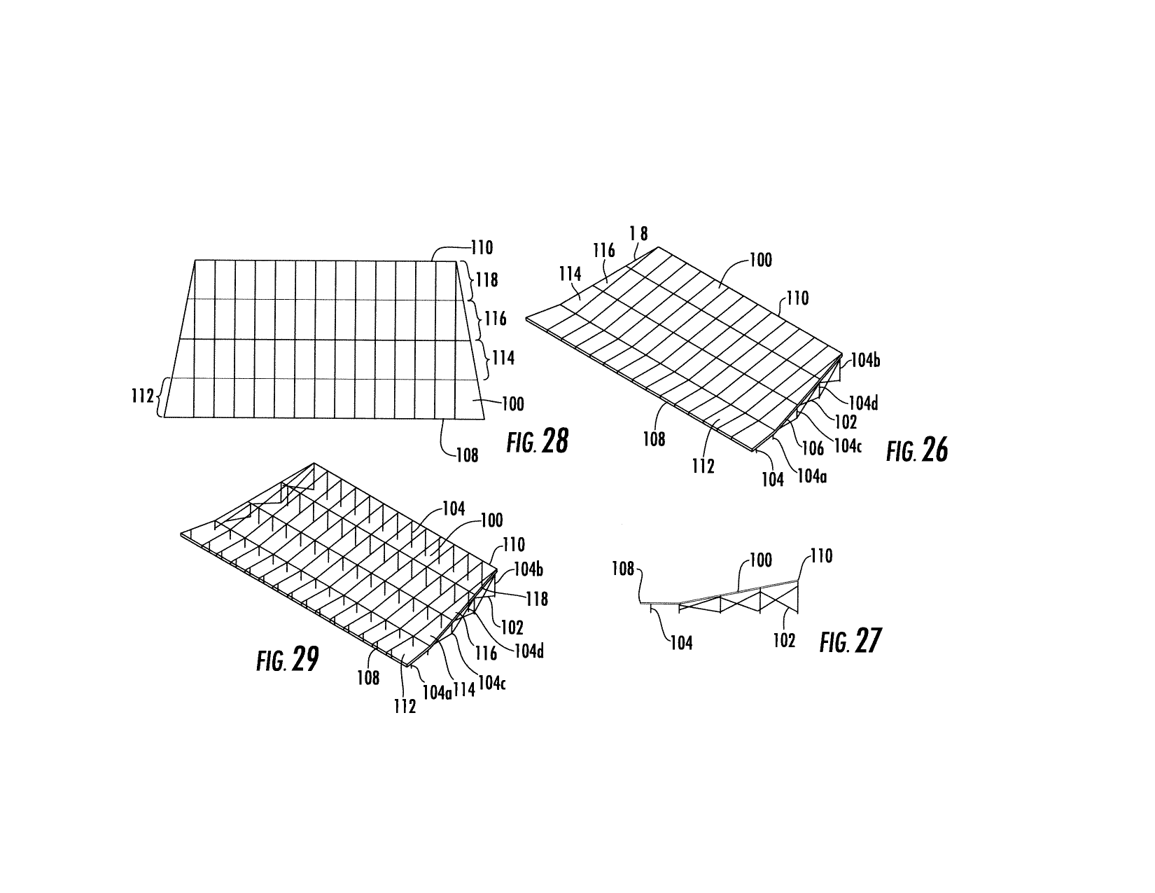

FIG. 27 is a side view of the bottom or stage screen 100 shown in FIG. 26 and illustrates the slope and rise, from front edge 108 to rear edge 110 of the bottom screen 100 shown in FIG. 26. The stage/bottom screen is supported by appropriate trussing 102 and cross and vertical beams or columns 104 for strength and support, as can be seen. The front edge 108 of the stage/bottom screen 100 can be elevated about 2 feet above ground level while the rear edge 110 is expected to be elevated to about 6 feet 8½ inches above ground—showing an increasing slope from front edge 108 towards rear edge 110. This figure also shows that the front portion 112 of the stage/bottom screen 100 may be substantially horizontal, with each attached and rearwardly located section 114, 116, and 118, of the stage/bottom screen 100 being progressively tilted, forwardly, towards the viewing audience.

FIG. 28 is a top plan view of the stage and bottom screen 100 shown in FIGS. 26 and 27, and shows the overall (when viewed from the top) trapezoidal shape of the stage/bottom screen 100 along with some dimensions, front edge preferably being about 64 feet and rear edge being about 52 feet, of a preferred stage for a performer and for the bottom video screen.

FIG. 29 is a top schematic view of the stage and bottom video screen 100 shown in FIGS. 26, 27 and 28 and shows the additional supporting beams below the stage (as if the stage and bottom screen were transparent). Clearly the supports 104a at the front edge 108 (see FIG. 29) of the bottom screen 100 are shorter in length, extending from below the planar floor defined by the bottom of the stage/bottom screen 100 to the floor of the arena, than the supports 104b at the rear edge 110 of the bottom screen 100, with the supports 104c and 104d, intermediate of the front and rear edges, 108 and 110, respectively, being increasingly long, from the front edge 108 towards the rear edge 110. The front section 112 is substantially horizontal to the ground and the vertical supports 104a will likely be about the same length for the floor surface at the front edge 108 and the rear of the front section 112.

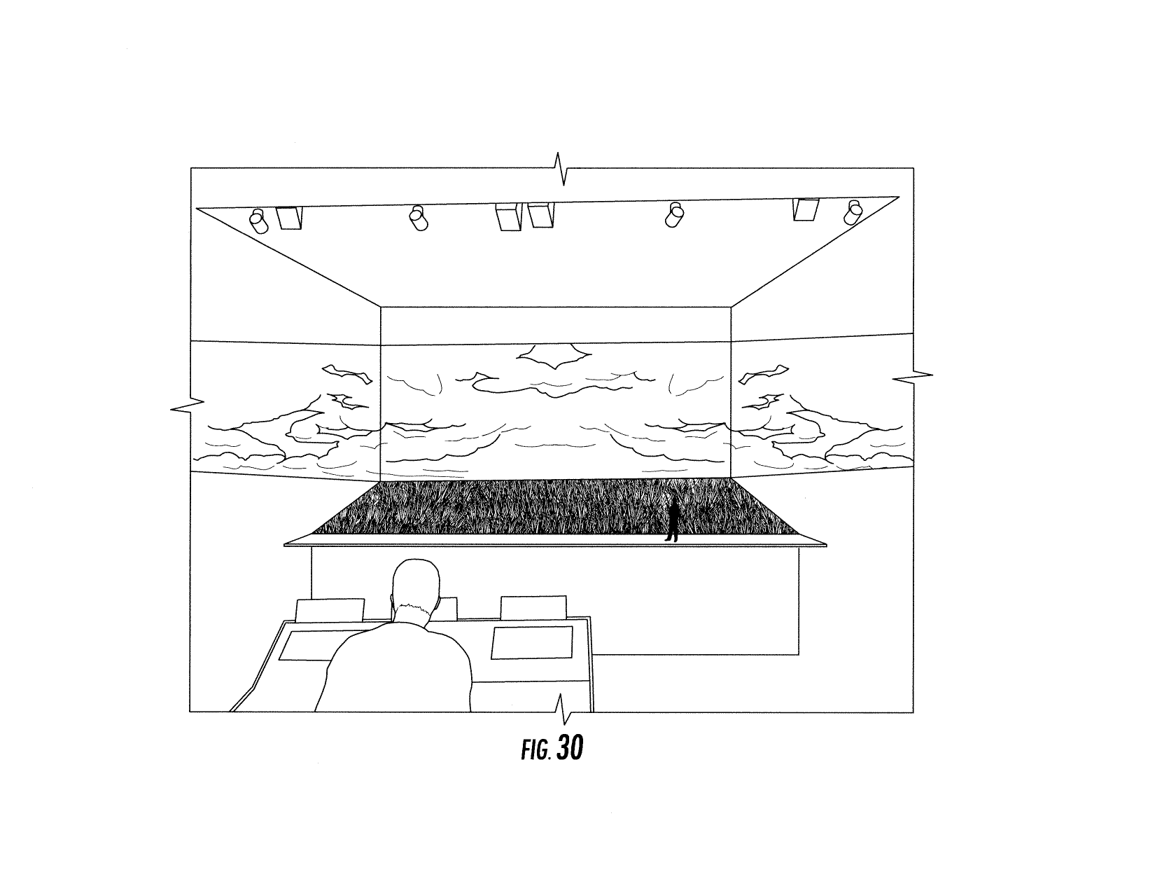

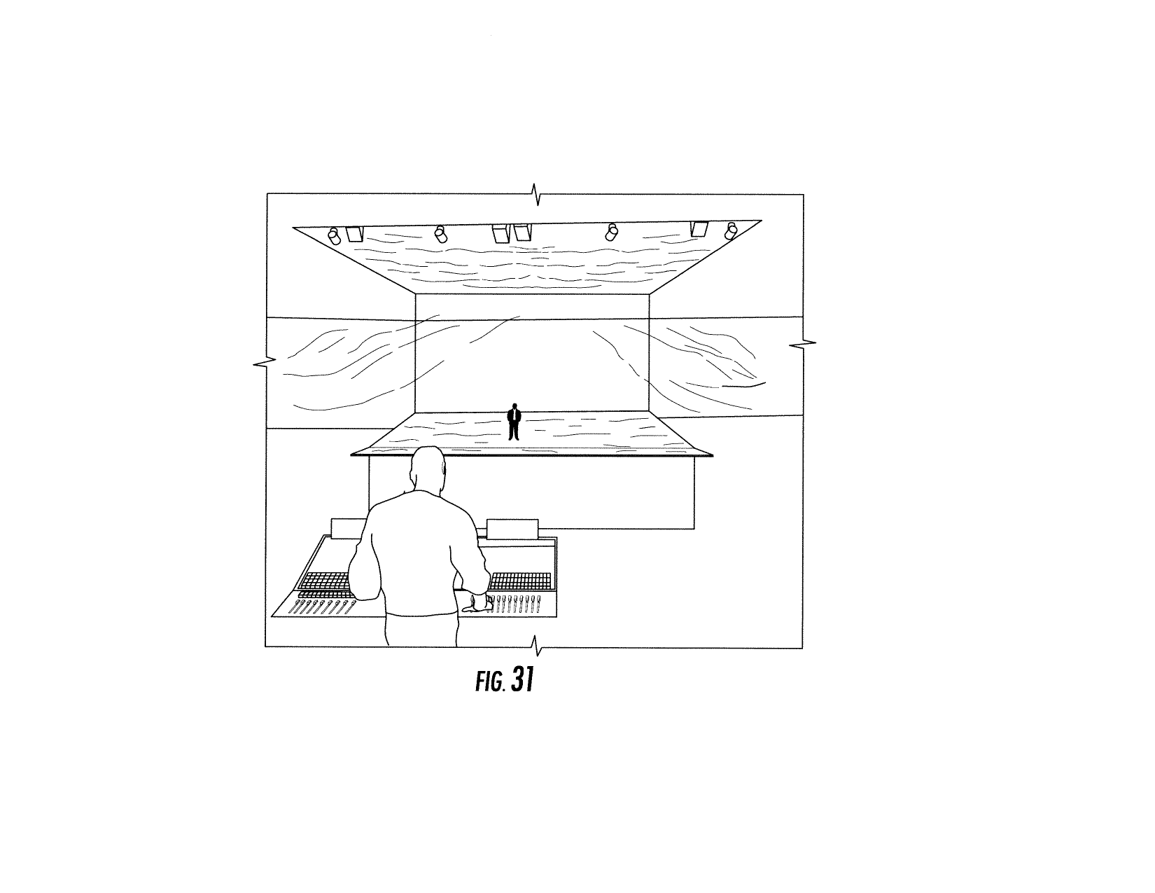

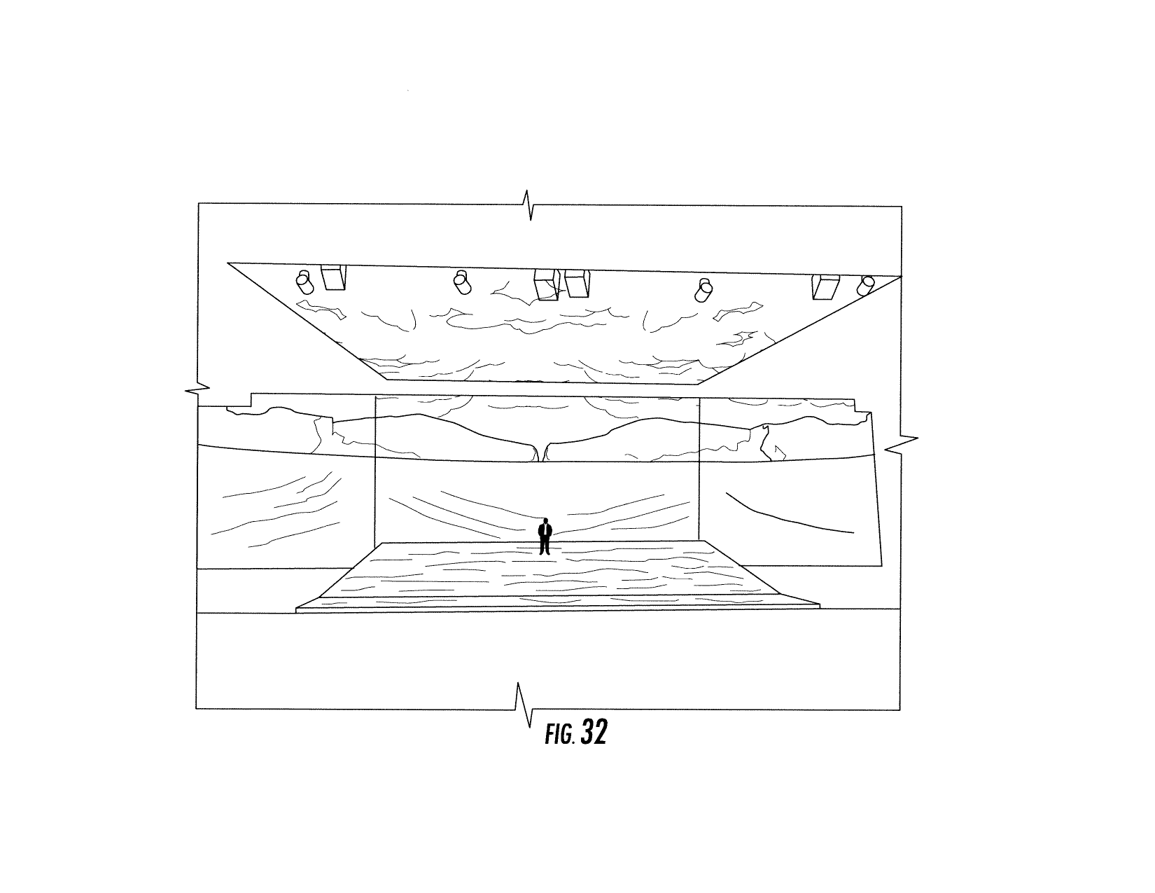

FIGS. 30-33 are comprised of four rehearsal/performance photos, originally submitted in color, and shows a concert stage in an arena, utilizing the present invention. As can be seen in some of the photos, the foreground shows a control console with one or more production personnel “manning” the console and attending to various aspects of the performance, e.g., lighting, video, audio, etc. Generally, the control console is behind at least some of the seating for the audience. The front wall of the arena is shown, too, having one or more front screens for video and the provision of substantially adjacent front screens and/or backwardly and outwardly canted or inclined side screens for video, too. The side walls of the theater/arena can also be provided with side video screens, too.

At the top of the arena is at least one ceiling or top video screen. The arena, shown in these photos, also shows use of the bottom or stage screen 100 (See FIGS. 26 through 29) for both the performers use as a stage for singing and/or dancing and standing upon and for selectively displaying video thereon. This stage or bottom screen 100 is similar in construction to that depicted in FIGS. 26 through 29. The last two photos, FIGS. 32 and 33, show a performer standing and walking on, respectively, the stage or bottom screen 100 and the video images presented thereon are visually related to the images shown on the front screens, the adjacent front screens and even the side wall screens. The third photo, FIG. 32, shows the stage or bottom screen 100 with the performer standing thereon, seemingly standing in water as the video projected onto the bottom screen 100 is that of water, with the front screens showing a visual continuation of the video view of water and in the distance, also projected onto the front, adjacent front and side wall screens, are shown glacial formations, in panorama. Here, the ceiling or top screen is a visual continuation, upwardly, of the view of the front screen(s) and shows beautiful, blue sky, extending above the glow/image of the top of the glacial shots, as shown on the front screen(s).

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed:

1. A system of providing realistic and immersive audio/video media content to one or more viewers in an environment comprising:
a set of video viewing screens comprising at least one front-located screen positioned in front of at least one viewer, and one or more screens of either:
an above, ceiling-like mounted screen located above the viewer(s);
a below, floor-like mounted screen located below the viewer(s);
a set of sound-reproducing speakers at least partially aligned with one or more of said screens;
an image projection system for projecting visual media content to said screens;
wherein visual media content projected onto said above, ceiling-like screen and/or said below, floor-like screen are spatially coordinated to the visual media content projected onto said front-located screen.

2. A system of providing realistic and immersive audio/video media content to one or more viewers in an environment as claimed in claim 1, wherein the number of screens is at least four comprised of one or more front-located screens, two side screens, at one or more of either or both of an above, ceiling-like mounted screen and a bottom, floor-like mounted screen.

3. A system of providing realistic and immersive audio/video media content to one or more viewers in an environment as claimed in claim 1, wherein said front located screen is of a panoramic type.

4. A system of providing realistic and immersive audio/video media content to one or more viewers in an environment as claimed in claim 3, wherein said front located screen is aligned and adjacent to canted screens at the front corners of the environment.

5. A system of providing realistic and immersive audio/video media content to one or more viewers in an environment as claimed in claim 1, further comprising two or more adjacent screens to said front screen, said adjacent screens being rearwardly tilted towards the viewer(s).

6. A system of providing realistic and immersive audio/video media content to one or more viewers in an environment as claimed in claim 1, wherein said video viewing screens further comprise one or both side-like screens in relation to said viewer(s).

7. A system of providing realistic and immersive audio/video media content to one or more viewers in an environment as claimed in claim 1, wherein both said above, ceiling-like mounted screen and said below, floor-like mounted screens are provided.

8. A system of providing realistic and immersive audio/video media content to one or more viewers in an environment as claimed in claim 1, wherein said below, floor-like screen is capable of being tilted upward off of the horizontal floor with its far edge elevated above the floor so that the below, floor-like screen is angled towards said viewer(s).

9. A system of providing realistic and immersive audio/video visual media content to one or more viewers in an environment as claimed in claim 1, wherein said bottom, floor-like screen is protected by a substantially transparent layer of material.

10. A system of providing realistic and immersive audio/video visual media content to one or more viewers in an environment as claimed in claim 1, wherein said audio components are coordinated to the projected visual media content to provide a surround sound experience.

11. A system of providing realistic and immersive audio/video visual media content to one or more viewers in an environment as claimed in claim 1, wherein said bottom, floor-like screen is located below the viewer(s) and yet at least slightly ahead of the eyes of the viewer(s).

12. A system of providing realistic and immersive audio/video visual media content to one or more viewers in an environment as claimed in claim 1, wherein said audio/video media content is a game and said projected images and audio are controlled by one or more viewers.

13. A system of providing realistic and immersive audio/video visual media content to one or more viewers in an environment as claimed in claim 12, wherein said viewer(s) control said game and the projected images onto said screens by interaction with a game controller.

14. A theater for displaying a multi-screen video immersive-like viewing experience comprising:
a three dimensional structure shaped for allowing easy ingress, egress and entertainment of a large audience through said/video immersive-like experience, said theater having seats for said audience substantially centrally located with respect to at least one front video screen and either one or both of an above, ceiling-like mounted screen and/or a below, floor-like mounted screen;
a means for projecting one or mores video image onto each of said screens, said images projected on each of said screens being different from one another yet spatially coordinated; and
wherein said above, ceiling-like screen is adapted to provide an overhead spatially-related view of the viewer(s) point of view based on the image projected on said front-located screen; and
wherein said bottom, floor-located screen is adapted to provide a downward spatially-related view of the viewer(s) point of view based on the image projected on said front-located screen.

15. A theater for displaying a multi-screen video immersive-like viewing experience as claimed in claim 14 further comprising a panoramic front viewing screen:

16. A theater for displaying a multi-screen video immersive-like viewing experience as claimed in claim 15 further comprising additional front screens rearwardly tilted towards the side walls of said theater.

17. A theater for displaying a multi-screen video immersive-like viewing experience as claimed in claim 14 further comprising one or more side wall-like screens which carry video images which are spatially correlated to the video image carried on said front screen.

18. A theater for displaying a multi-screen video immersive-like viewing experience as claimed in claim 14 comprising both an above, ceiling-like mounted screen and a below, floor-like mounted screen.

19. A theater for displaying a multi-screen video immersive-like viewing experience as claimed in claim 14 further comprising one or more substantially continuous front screens displaying a panoramic-like video image, one or more side-located screens and both an above, ceiling-like screen and a below, floor-like mounted screen, with all of said screens projecting and having viewable thereon a set of video media content which are spatially coordinated to that projected onto said front screens.

20. A theater for displaying a multi-screen video immersive-like viewing experience as claimed in claim 19 further comprising a surround-sound-like audio system.

21. A theater for displaying a multi-screen video immersive-like viewing experience as claimed in claim 19 wherein said below, floor-like screen is tilted with the distal edge thereon elevated above the proximal edge.

22. A theater for displaying a multi-screen video immersive-like viewing experience as claimed in claim 21, wherein said distal edge of said below, floor-like screen is located above the floor of said theater.

23. A theater for displaying a multi-screen video immersive-like viewing experience as claimed in claim 14 wherein the floor or the housing portion of said theater is capable of being raised or tilted by means of hydraulic lift mechanisms.

24. A theater for displaying a multi-screen video immersive-like viewing experience as claimed in claim 14 wherein said outside housing for said theater is substantially comprised of either a pyramid, cube, parallelepiped or hemi-sphere or mixtures thereof

25. A video immersive-viewing video system comprising:
a video monitor device for displaying a video image on a first section thereof;
a video image memory having a set of stored video images spatially related to one another;
a device for selecting video images from said video image memory for display on said first section of said video monitor device;
a CPU for processing said video images and projecting the same onto said video monitor device;
and said video monitor device being divided into at least two separate viewing areas, one of which is said first section and the other(s) separate viewing area(s) being separated therefrom and providing spatially corresponding image(s) to that shown on said first section, said spatially corresponding images being selected from said video image memory as said video image on said first section changes.

26. A video immersive-viewing video system as claimed in claim 25, wherein said device is a joystick or other mechanical device electronically connected to said video image memory.

27. A video immersive-viewing video system as claimed in claim 25, wherein said other of said separate viewing areas are trapezoidal in shape and providing perspective views of said video image displayed in said first section.
